(19) United States
(12) Patent Application Publication
(10) Pub. No.: US 2026/0287372 A1
(43) Pub. Date: Sep. 24, 2026

(54) SYSTEM

(71) Applicant: SoftBank Group Corp., Tokyo (JP)

(72) Inventor: Hiroyuki MIZUNO, Tokyo (JP)

(73) Assignee: SoftBank Group Corp., Tokyo (JP)

(21) Appl. No.: 19/562,835

(22) Filed: Mar. 11, 2026

(30) Foreign Application Priority Data
Mar. 19, 2025 (JP) 2025-044946

(51) Int. Cl. G01C 21/34

(52) U.S. Cl. CPC G01C 21/3461

(57) ABSTRACT

A system includes a processor that is configured to obtain earthquake information by using at least one sensor and at least one database that collect earthquake information, generate a prompt for evaluating a degree of danger by using a generative AI model based on the obtained earthquake information, generate a prompt for instructing acquisition of shelter information based on the evaluated degree of danger, generate a prompt for proposing an optimal evacuation route based on the shelter information and current location information, and transmit the proposed evacuation route to a terminal of a user.

### CROSS-REFERENCE TO RELATED APPLICATION

This application is based on and claims priority under 35 USC 119 from Japanese Patent Application No. 2025-044946 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional disaster prevention systems for earthquakes generally rely on fixed rules or predesigned algorithms to evaluate danger levels, select shelters, and determine evacuation routes. Such systems often lack flexibility and adaptability when facing complex, real-time changes in earthquake parameters, road conditions, and traffic conditions. As a result, the evaluated danger level may not sufficiently reflect the actual situation, the selected shelter may not be optimal for the user, and the proposed evacuation route may be suboptimal or even unsafe. Furthermore, conventional systems typically do not leverage generative AI models and prompt-based processing, and therefore cannot easily integrate diverse information sources into a unified, context-aware decision process. Accordingly, there is a need for a system that can dynamically evaluate a danger level based on detailed earthquake information, autonomously acquire appropriate shelter information according to the evaluated danger level, and propose an optimal evacuation route by flexibly combining shelter information and current location information, while being capable of utilizing generative AI models through prompt generation.

### SUMMARY

In order to solve the above-described problem, a system according to one embodiment of the present invention comprises a processor configured to obtain earthquake information by using at least one sensor and at least one database that collect earthquake information, to generate a prompt for evaluating a degree of danger by using a generative AI model based on the obtained earthquake information, to generate a prompt for instructing acquisition of shelter information based on the evaluated degree of danger, to generate a prompt for proposing an optimal evacuation route based on the shelter information and current location information, and to transmit the proposed evacuation route to a terminal of a user. In one aspect, the processor is configured to generate the prompt for evaluating the degree of danger by using, as input data, information including at least one of an earthquake magnitude, an epicenter, an earthquake depth, an earthquake occurrence time, and elapsed time after the earthquake occurrence, and to evaluate the degree of danger by using the generative AI model based on the generated prompt. In another aspect, the processor is configured to input, into the generative AI model, a prompt including at least one of current location information, shelter information, road condition information, and traffic condition information, and to generate the prompt for proposing the optimal evacuation route based on output from the generative AI model. By these means, the system can flexibly integrate diverse disaster-related information and can provide a highly adaptable, context-aware danger evaluation and evacuation route guidance that improves safety and usability for the user.

The term “processor” refers to any hardware and/or software component, including a CPU, GPU, microcontroller, or a combination thereof, that executes instructions to perform the functions described in the present specification and claims.

The term “earthquake information” refers to information relating to an occurrence of an earthquake, including, but not limited to, at least one of an earthquake magnitude, an epicenter, an earthquake depth, an earthquake occurrence time, and elapsed time after the earthquake occurrence.

The term “sensor” refers to any device or system that detects physical phenomena associated with an earthquake, such as ground motion, acceleration, or vibration, and outputs corresponding data usable as part of the earthquake information.

The term “database” refers to any structured or unstructured data storage system, including local or remote storage, that stores earthquake information, shelter information, road condition information, traffic condition information, or other related information.

The term “generative AI model” refers to any artificial intelligence model, including but not limited to large language models and other generative models, that is capable of generating outputs such as text, prompts, or recommendations based on input data and prompts.

The term “prompt” refers to information formatted as an input instruction or query for a generative AI model, the information including data, context, constraints, or requirements used by the generative AI model to produce a corresponding output.

The term “degree of danger” refers to any quantitative or qualitative evaluation value that represents a risk level associated with an earthquake for a given area, time, or condition, as determined based on earthquake information and optionally other related information.

The term “shelter information” refers to information regarding one or more shelters available for evacuation, including, but not limited to, at least one of shelter location, capacity, available facilities, operational status, and associated administrative region.

The term “current location information” refers to information indicating a present geographic position of a user or a user terminal, such as latitude and longitude coordinates or an equivalent location representation.

The term “evacuation route” refers to a path or sequence of segments connecting a current location to a shelter, the path being determined or proposed based on at least one of distance, safety, road conditions, and traffic conditions.

The term “road condition information” refers to information describing the state of roads, including, but not limited to, road closures, damage, accessibility, and passability in the context of an earthquake or other disaster.

The term “traffic condition information” refers to information describing traffic states, including, but not limited to, congestion levels, traffic flow, restrictions, and other factors affecting movement along roads or paths.

The term “terminal” refers to any user-operated device capable of communicating with the system, including, but not limited to, a smartphone, tablet, personal computer, or dedicated communication device, that can receive evacuation routes and related information.

The term “user” refers to any person who uses the terminal and receives danger evaluations, shelter information, and evacuation route guidance provided by the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

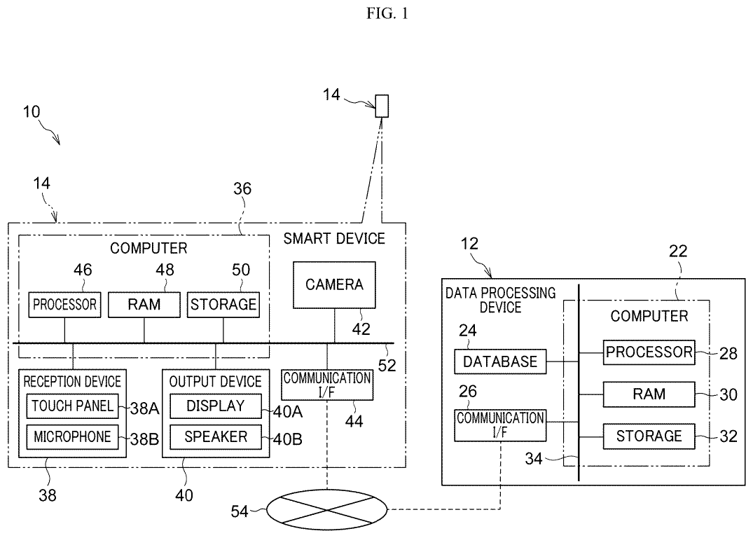

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

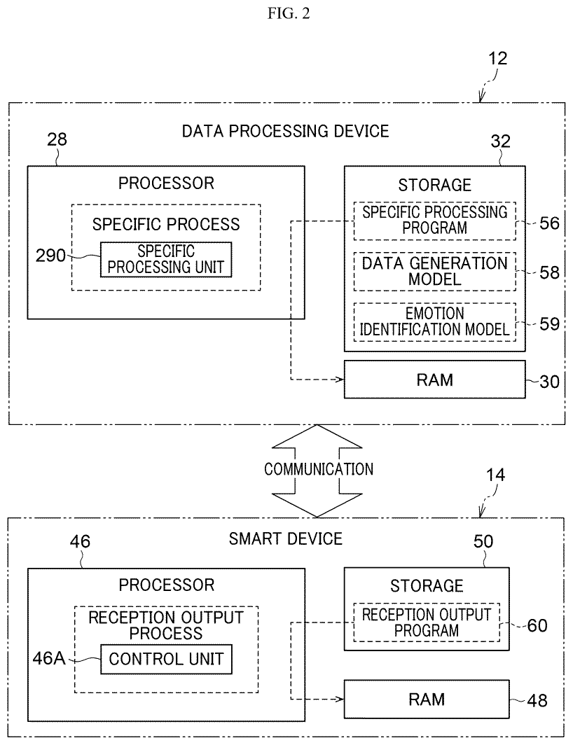

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional evacuation support systems for disaster events, such as earthquakes or other large-scale incidents, typically combine multiple heterogeneous software components in an ad hoc manner: a data collection module that polls external information sources, a calculation module that heuristically estimates regional risk, a separate routing engine that computes candidate paths, and a user interface module that presents static guidance. These components are often loosely coupled via manual configuration or static rule sets, and the systems are not designed to leverage generative AI models and prompt sentences as first-class computational elements in the decision pipeline. As a result, several technical problems arise in terms of computer technology itself.

First, in known systems, the integration of observational data, dynamically computed risk indices, external route and facility information, and natural language explanations is fragmented. The processor typically performs risk evaluation and route computation using fixed algorithms and then separately invokes a generative AI model, if at all, merely to paraphrase already-computed results. Such architectures require duplicate data conversions and redundant processing steps, increasing processing latency and memory usage in the processor, because the same underlying information must be transformed into several incompatible intermediate formats for different subsystems.

Second, conventional systems do not treat the generation and control of prompt sentences as a structured, processor-level function. Prompts are commonly constructed in an unstructured, ad hoc fashion, directly in the application code or user interface layer. This leads to non-deterministic behavior of the generative AI model, difficulty in verifying or debugging its outputs, and inefficient utilization of computational resources. Without a dedicated prompt generation mechanism that systematically composes prompt sentences from observation information, risk indices, position information, refuge facility information, and route constraint information, the processor cannot reliably control how the generative AI model fuses and interprets heterogeneous data inputs.

Third, existing systems typically compute routes and select facilities either (i) fully outside any generative AI workflow, or (ii) entirely inside the generative AI model as opaque reasoning steps. In the first case, the processor fails to exploit the generative model's ability to synthesize contextual explanations and tradeoffs, while in the second case the processor delegates critical path selection logic to a black box, where the internal computations are not aligned with structured route metrics or safety constraints. Both approaches degrade the reliability and predictability of route selection processing, and prevent efficient caching, re-use, and comparison of multiple route candidates at the processor level.

Fourth, when natural language explanations for risk indices and evacuation routes are produced, existing systems usually generate such explanations either manually or via separate post-processing steps that are not integrated with the core computation. This separation forces the processor to repeat database lookups and re-compute derived values solely for explanatory purposes, resulting in unnecessary CPU load, increased memory transfers, and additional network transactions between a server and a terminal device.

Therefore, there is a need in the field of computer technology for an improved system architecture and processing method in which: (i) a processor centrally orchestrates acquisition and storage of observation information, computation of area-based risk indices, generation of structured prompt sentences for a generative AI model, extraction and evaluation of multiple evacuation route candidates, and association of routes with natural language explanation data; (ii) the generative AI model is invoked under explicit and verifiable control via structured prompt sentences generated by a dedicated prompt generation unit; and (iii) the resulting evacuation facility and route information, including explanatory information, is transmitted to a terminal device as coherent, computation-ready route data. Such an architecture improves the technical operation of the computer system itself, by reducing redundant processing, improving determinism and traceability of generative AI outputs, and optimizing the way the processor uses memory, storage, and external information provision units when supporting evacuation guidance.

The specific processing by the specific processing unit 290 of the data processing device 12 in Example 1 is realized by the following means.

The present invention provides a server comprising a processor configured to acquire observation information by using an observation information acquisition unit, store the observation information in an information storage unit, calculate a risk index for each predetermined area based on the observation information by an arithmetic unit, generate request information to an external information provision unit for acquiring refuge facility information and route information based on the risk index and position information by a generation unit, generate a prompt sentence to be input to a generative information processing model by a prompt generation unit, the prompt sentence including as input elements at least the observation information, the risk index, the position information, the refuge facility information, and route constraint information, extract refuge facility candidates and a plurality of evacuation route candidates from response information output from the generative information processing model, evaluate the evacuation route candidates using predetermined route evaluation metrics, specify an optimal evacuation route by a route selection unit, and transmit route data including a sequence of positions constituting the optimal evacuation route, guidance instructions, and explanatory information to a terminal device by a communication unit. This enables the processor to perform an integrated, computer-implemented pipeline that unifies structured numerical computation and generative AI processing under explicit prompt control, thereby reducing redundant data transformations, improving determinism and traceability of generative model outputs, optimizing use of external information provision units, and enhancing the overall performance and reliability of evacuation route computation and presentation in the server-terminal computer system.

The term “observation information” refers to digital data representing measured or detected characteristics of an event or environment, including but not limited to magnitude, occurrence position, depth, occurrence time, and elapsed time after occurrence, which is obtained from one or more sensing devices or external information sources and is used as an input to computational processing.

The term “observation information acquisition unit” refers to a hardware or software component, or a combination thereof, that is configured to obtain observation information from one or more data sources, such as sensors, external information provision systems, or communication networks, and to supply the obtained observation information to a processor.

The term “information storage unit” refers to a hardware or software component, or a combination thereof, that is configured to store digital information in a non-transitory storage medium, such as a memory device or a storage device, and to allow the stored information to be read and updated by a processor.

The term “arithmetic unit” refers to a hardware or software component, or a combination thereof, that is configured to perform numerical calculations or logical operations on input data, including computation of a risk index for each predetermined area based on observation information.

The term “risk index” refers to a numerical or categorical indicator computed from observation information and optionally other parameters, which represents a relative level of predicted or estimated danger or impact for a predetermined area.

The term “predetermined area” refers to a spatial region defined in advance according to a certain granularity, such as an administrative region, grid cell, or geographic zone, for which a risk index or other computed values are calculated.

The term “generation unit” refers to a hardware or software component, or a combination thereof, that is configured to generate structured digital data, including request information to an external information provision unit and other intermediate data, based on input parameters such as a risk index and position information.

The term “external information provision unit” refers to an external system, service, or device, accessible via a communication network, that is configured to provide information such as refuge facility information, route information, road condition information, or traffic condition information in response to request information.

The term “refuge facility information” refers to digital data representing attributes of one or more facilities designated or usable as evacuation destinations, including but not limited to facility position, capacity, availability, and equipment information.

The term “route information” refers to digital data representing one or more possible paths between positions in a spatial domain, including but not limited to sequences of coordinates, travel times, distances, and associated constraints or conditions.

The term “position information” refers to digital data identifying a location in a spatial domain, such as a coordinate pair or other locational representation, which may indicate a user position, a facility position, or an intermediate waypoint.

The term “route constraint information” refers to digital data specifying conditions or limitations applicable to route computation or selection, including but not limited to road closures, traffic restrictions, accessibility requirements, or safety constraints.

The term “prompt generation unit” refers to a hardware or software component, or a combination thereof, that is configured to construct and output a prompt sentence in natural language or a structured representation, based on one or more input elements including observation information, a risk index, position information, refuge facility information, and route constraint information.

The term “prompt sentence” refers to a sequence of symbols, including natural language text and optional structured tokens, formatted to be input to a generative information processing model for causing the model to perform a requested processing, such as evaluation, explanation, or recommendation.

The term “generative information processing model” refers to a computational model, implemented in hardware or software, that is configured to generate output data such as natural language text or structured information in response to an input including a prompt sentence, by using learned parameters obtained through machine learning.

The term “response information” refers to output data generated by the generative information processing model in response to a prompt sentence, including but not limited to textual explanations, recommended facilities, and suggested routes.

The term “route selection unit” refers to a hardware or software component, or a combination thereof, that is configured to receive candidate refuge facilities and candidate evacuation routes, evaluate the candidates according to predetermined route evaluation metrics, and specify an optimal evacuation route.

The term “evacuation route candidate” refers to a possible path from a starting position to a refuge facility, represented as route information, which is subject to evaluation by the route selection unit.

The term “optimal evacuation route” refers to a selected evacuation route candidate that satisfies one or more optimization criteria, such as minimum estimated travel time, acceptable distance, and compliance with safety or constraint conditions, according to predetermined route evaluation metrics.

The term “route evaluation metrics” refers to one or more quantitative or qualitative measures used to compare and rank evacuation route candidates, including but not limited to travel time, distance, risk level, congestion, or accessibility.

The term “communication unit” refers to a hardware or software component, or a combination thereof, that is configured to transmit and receive digital data between a server and one or more external devices, such as terminal devices or external information provision units, via a communication network.

The term “route data” refers to digital data describing an evacuation route, including at least a sequence of positions constituting the route, guidance instructions corresponding to the route, and explanatory information associated with the route.

The term “sequence of positions” refers to an ordered collection of position information elements that together represent a path in a spatial domain along which a user or object is intended to move.

The term “guidance instructions” refers to digital data representing step-by-step indications or directions, in textual, symbolic, or audio form, that instruct a user how to traverse an evacuation route.

The term “explanatory information” refers to digital data, typically in natural language form, that describes or justifies a computed result, such as a risk index, a selected refuge facility, or an optimal evacuation route, including reasons for selection or evaluation.

The term “terminal device” refers to an information processing device, such as a portable terminal, a fixed terminal, or any other user-operated computing apparatus, that is configured to receive route data and explanatory information and to present at least part of the received data to a user.

In one embodiment, a server, a terminal, and a user cooperate to implement the present invention. The server includes at least one processor, a memory, a non-transitory storage device, and a network interface. The terminal includes at least one processor, a memory, a display, an audio output device, a location sensor such as a GPS receiver, and a network interface. The user operates the terminal.

The server executes an operating system such as a general-purpose server operating system, and the server runs application software including (i) an observation information acquisition module, (ii) an information storage module, (iii) a numerical risk computation module, (iv) a prompt generation module, (v) a generative AI interface module, (vi) a route selection module, and (vii) a communication module. The server may implement these modules as distinct processes or as logically separated components within a single process. The terminal executes a client application that communicates with the server via a network such as a packet-switched network.

The server uses the observation information acquisition module to obtain observation information. The server, in one configuration, uses an HTTP client library on the server to send network requests to one or more external information provision systems that supply event data, such as seismic event data or other disaster-related event data. The server receives digital data such as event magnitude, event occurrence position coordinates, event depth value, event occurrence time, and elapsed time after occurrence. The server normalizes formats of timestamps, converts coordinate systems if needed, and validates that all required fields are present. The server then stores the cleaned records in the information storage module.

The server implements the information storage module by using a database management system such as a relational database system running on the storage device. The server defines tables for at least observation information, area definitions, risk indices, facility information, route candidates, and explanation logs. The server uses an index structure such as a B-tree index or an R-tree index to speed up retrieval based on time, area identifier, or coordinates. The server, by storing time-series observation information in a structured schema, reduces redundant parsing operations and improves cache locality in the processor, thereby increasing throughput when the server later retrieves data for computation.

The server uses the numerical risk computation module as an arithmetic unit. The server, in one embodiment, implements this module in a language capable of efficient numerical computation and uses numerical libraries for vector and matrix operations. The server preloads area definitions as polygons or grid cells and maintains a mapping between observation information and affected areas. The server computes a risk index for each predetermined area by applying a numerical model that combines event magnitude, distance between the event occurrence position and a representative point of the area, depth value, and elapsed time after the event. The server, for example, computes a weighted sum of normalized features and applies a temporal attenuation factor to account for the decay of after-effects over time.

The server, by computing the risk index in a vectorized manner over multiple areas and multiple events, improves processing efficiency compared to iterative or purely rule-based computations. The server stores the resulting risk indices in the database, associating each risk index with an area identifier and a timestamp. This arrangement enables the server to answer later queries for risk indices with a small number of indexed lookups, which reduces latency and CPU load.

The server uses a generation unit to generate request information to one or more external information provision units based on the risk index and position information. The server constructs, for example, a request message that includes a target region identifier or bounding coordinates and a risk threshold. The server transmits this request via the communication module to an external system that manages refuge facility information and to another external system that provides route or road network information. The server receives refuge facility information including facility coordinates, capacity values, availability status, and facility type information. The server also receives route information such as precomputed network graphs, link costs, or candidate paths. The server normalizes and stores these data elements in appropriate tables and data structures.

The server uses the prompt generation module as a prompt generation unit. The server constructs a prompt sentence for a generative AI model by composing natural language segments and structured tokens from internal data structures. The server, for example, selects fields such as current risk index value for a particular area, description of event magnitude and location, list of candidate refuge facilities, and constraints such as closed roads or congestion levels, and the server serializes these fields into a prompt sentence template. The server explicitly controls the layout of the prompt sentence so that the generative AI model receives observation information, risk indices, position information, refuge facility information, and route constraint information in a deterministic order. This design permits reproducible behavior and simplifies debugging because the same internal data always map to the same prompt sentence form.

The server, in one implementation, uses a generative AI interface module to call a generative AI model implemented as a neural network. The server may connect to a remote generative AI inference service or execute a local inference engine. The generative AI model, in one embodiment, is a transformer-type neural network consisting of multiple self-attention layers, feed-forward layers, and layer normalization, with learned parameters obtained through pre-training on large corpora and optionally fine-tuned on domain-specific data including disaster reports and routing explanations. The server specifies model parameters such as maximum token length, decoding temperature, and top-k or top-p sampling thresholds for controlling output variability.

The server, before calling the generative AI model, transforms internal numeric values, such as risk indices, distances, and capacities, into human-readable descriptions or tagged tokens within the prompt sentence, so that the model receives not only raw text but also explicit markers indicating which parts correspond to risk measures or constraints. This structured prompt design allows the generative AI model to apply learned patterns to a well-defined set of features, yielding consistent and technically meaningful output.

The server uses the route selection module to interpret response information from the generative AI model. The server receives response information that may contain textual descriptions of recommended refuge facilities and high-level route preferences. The server parses the response using pattern matching or token-based extraction to identify facility identifiers or route descriptors. The server does not rely solely on the generative AI model for computing route geometries; instead, the server uses the generative AI model to propose or rank high-level strategies, such as preference for low-risk zones or avoidance of particular routes, and the server then applies deterministic algorithms to compute exact paths on the network graph.

The server represents the road network as a directed graph, with vertices associated with coordinates and edges associated with travel time, distance, and an edge risk penalty computed from proximity to high-risk areas. The server runs a path search algorithm such as Dijkstra's algorithm or an A* algorithm using a heuristic that incorporates both distance and risk penalty. The server generates multiple route candidates by altering weights or constraints and compares them using route evaluation metrics such as total travel time, cumulative risk score along the path, and expected congestion. The server uses preference information derived from the generative AI output as additional weights or filters in the route evaluation process. This combined numerical-generative approach enables the server to maintain predictable and verifiable route computation while leveraging the generative AI model for refined selection and explanation.

The server packages the final selected path as route data. The server encodes a sequence of positions as an ordered list of coordinates, associates each segment with guidance instructions such as “proceed straight for 200 meters” or “turn left at the next intersection,” and attaches explanatory information that describes why a specific refuge facility and route were chosen, referring to risk index values, facility capacity, and road conditions. The server stores this route data in memory and transmits it through the communication module to the terminal.

The terminal receives route data and explanatory information from the server via the network interface. The terminal stores the incoming data in memory and renders the route on a map display using a mapping software library. The terminal translates the sequence of positions into polylines, draws them on the display, and places markers at key points such as the starting location, intermediate waypoints, and the refuge facility. The terminal converts textual guidance instructions into on-screen messages and optionally into speech output by invoking a text-to-speech engine built into the terminal's operating system. The terminal, by delegating heavy computations such as risk index calculation and route graph search to the server, reduces its own power consumption and processing load, which is advantageous for mobile devices with limited resources.

The user operates the terminal to initiate processing. The user, in one example, opens an evacuation support application and allows the terminal to access its location sensor. The terminal acquires position information in the form of latitude and longitude, combines it with user-provided contextual information such as the name of a district, and sends this information to the server. The user may also directly provide a natural-language request to the system.

The user, as a concrete example, may input the following prompt sentence to the system: “Currently, I am in Shibuya Ward, Tokyo. An earthquake has occurred. The epicenter is in Kanagawa Prefecture, the magnitude is 7.0, and the depth is 10 km. Please tell me the optimal evacuation shelter and evacuation route, and explain why this shelter and route are recommended.”

The server receives this natural-language input from the terminal and uses a pre-processing function to extract structured elements such as area name, event magnitude, approximate epicenter region, and depth. The server then uses these extracted values to query observation information and area definitions from the database, to compute or retrieve risk indices, and to identify candidate refuge facilities. The server integrates these elements into a prompt sentence designed for the generative AI model and invokes the generative AI interface module to obtain contextual explanation and ranking information. The server then performs deterministic route computations guided by these outputs and returns final route data and explanations to the terminal.

The server, in another embodiment, uses training data to adapt the generative AI model to evacuation-specific explanations. The server constructs a training dataset comprising pairs of structured inputs (risk indices, facility attributes, route metrics) and human-authored explanations or route rationales. The server uses supervised fine-tuning, where the generative AI model parameters are updated by minimizing a loss function such as cross-entropy between model-generated tokens and reference tokens. The server then optionally applies reinforcement learning based on user feedback, where route acceptability scores or explicit user ratings are used to refine the model's parameters. By aligning the generative AI model with structured internal metrics, the server ensures that generated explanations correlate with actual numerical risk and route data, which improves trust and usability while maintaining technical correctness.

The server, in a further embodiment, implements several alternative numerical strategies for computing the risk index. The server may use a logistic function that maps a linear combination of normalized features to a bounded risk score, or the server may use a small feed-forward neural network trained specifically on historical event-impact data. The server uses a training dataset of past events and observed damage counts per area, and the server trains the risk model by minimizing a loss function such as mean squared error between predicted and actual damage indices. The server then uses the trained model in inference mode, where the processor performs a fixed set of matrix multiplications and nonlinear activations for each new event. This design provides improved accuracy over simple heuristic formulas while still being deterministic and explainable at the level of model parameters and features.

The server, by centralizing observation data storage, risk computation, prompt generation, generative AI interaction, and route selection in a unified architecture, reduces duplication of data transformations and eliminates the need for separate intermediary systems to convert between incompatible formats. The server, as a consequence, reduces the number of database queries and network requests required per user session. The server, for example, can reuse cached risk indices and facility data for multiple users in the same area, while customizing prompt sentences and route selections at the individual user level. This configuration directly lowers processing latency, improves throughput for many concurrent requests, and reduces network bandwidth usage.

The server, in alternative embodiments, may employ different generative AI models and different route computation strategies. The server may use a smaller, locally deployed language model for environments where network connectivity to a remote inference service is limited. The server may also deploy multiple generative AI models specialized for different tasks, such as a first model used to prioritize which areas require computation and a second model used to generate user-facing explanations. The server may use different graph search algorithms and heuristic functions depending on whether the user is expected to travel by foot, by vehicle, or by mixed modes. The system architecture remains compatible with these variations because the prompt generation module and the route selection module rely on clearly defined internal data structures, such as typed records for observation information, risk indices, facility attributes, and graph edges.

The terminal, in an additional embodiment, can operate in a partially offline mode. The terminal may cache a set of refuge facility locations and previously computed route templates. When network connectivity is temporarily unavailable, the terminal can still display approximate routes and basic guidance. When connectivity resumes, the terminal transmits newly acquired position information and user requests to the server, and the server updates route data with current risk indices and road conditions. This design improves robustness and safety in environments where communication links are intermittent.

The user thus interacts with a system in which the server and the terminal cooperate to provide dynamic, risk-aware, and explanation-rich evacuation guidance. The use of a generative AI model, controlled via structured prompt sentences and integrated with deterministic numerical and graph-based computation, constitutes not merely an automation of human decision making, but an improvement in computer technology itself. The server systematically reduces redundant computation, optimizes memory and database access patterns, constrains and structures natural-language input and output, and couples generative outputs with verifiable numerical evaluation, thereby enhancing precision, speed, and reliability of evacuation route computation and presentation in comparison with conventional architectures.

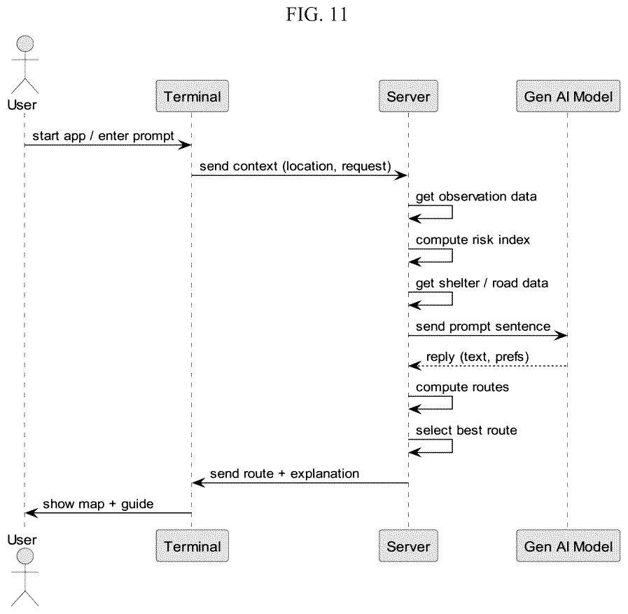

The following describes the processing flow using FIG. 11.

### Step 1:

The server acquires observation information.

The server, as input, receives no user-specific data but uses configuration data specifying one or more external information provision endpoints. The server periodically sends network requests, for example HTTPS GET requests, to external information provision units that supply event-related observation information, such as magnitude, occurrence position, depth, occurrence time, and elapsed time after occurrence. The server, upon receiving response messages in a structured format such as JSON, validates schemas, converts timestamps to a unified time zone, transforms coordinate representations into a standard coordinate system, and discards incomplete or inconsistent records. The server outputs normalized observation information records and stores them in an information storage unit, such as a relational database.

### Step 2:

The server computes a risk index for each predetermined area.

The server, as input, retrieves from the information storage unit a set of observation information records and a set of area definition records that define spatial regions by polygons or grid cells. The server uses an arithmetic unit to compute, for each area, numeric features such as distance from the event occurrence position to a representative point of the area, attenuation factors based on depth and elapsed time, and a normalized magnitude component. The server combines these features by applying a predefined function, for example a weighted sum followed by a nonlinear scaling function such as a logistic function, to obtain a risk index value. The server outputs area-risk index pairs and stores them in a risk index table indexed by area identifier and timestamp.

### Step 3:

The server generates request information for external refuge facility and route data.

The server, as input, uses the computed risk index values and position information indicating one or more target regions, which may be derived from user location, administrative boundaries, or both. The server evaluates whether the risk index for a region exceeds a threshold and, if so, constructs request information containing region identifiers, bounding coordinates, and optional risk category labels. The server uses this request information to call external information provision units responsible for refuge facility information and route or road network information. The server receives, as output, facility data including facility coordinates, capacities, availability flags, and types, as well as route-related data such as graph nodes, edges, and edge attributes, and then stores the received data in dedicated tables or in-memory data structures.

### Step 4:

The server generates a prompt sentence for a generative AI model.

The server, as input, takes observation information, risk index values for relevant areas, user position information, refuge facility information, and route constraint information such as closed roads or congestion levels. The server uses a prompt generation unit to assemble a prompt sentence in natural language by inserting these input elements into a predefined template, arranging them in a fixed order, and annotating them with explicit labels (for example, “RISK_INDEX: 0.82” or “FACILITY_CAPACITY: 500”). The server thereby performs data transformation from internal numeric and structured formats into a textual sequence suitable for a generative AI model. The server outputs a complete prompt sentence that encodes both numerical and semantic context for later inference.

### Step 5:

The server invokes the generative AI model and receives response information.

The server, as input, uses the generated prompt sentence and model configuration parameters such as maximum token length and decoding strategy. The server sends a request containing the prompt sentence to a generative AI model endpoint, which may be hosted locally or remotely, and waits for a response. The server receives, as output, response information in the form of natural language text that includes recommended refuge facility identifiers or descriptions, high-level route preferences, and explanatory content. The server parses the response using pattern matching or tokenization to extract structured elements, and the server stores both the raw response text and the extracted structured fields in the information storage unit for traceability.

### Step 6:

The server selects an optimal evacuation route using numerical computation guided by generative output.

The server, as input, uses the structured elements extracted from the generative AI response (such as recommended facility identifiers and preferred avoidance zones), the refuge facility information, the risk indices, and the road network graph obtained earlier. The server computes multiple evacuation route candidates by running a path search algorithm, such as Dijkstra or A*, on the road network graph. The server assigns to each edge a composite cost that includes base travel time or distance plus a risk penalty derived from proximity to high-risk areas and any constraints indicated by the generative output. The server evaluates each route candidate according to route evaluation metrics, such as total composite cost, expected travel time, cumulative risk score along the path, and number of turns. The server outputs an optimal evacuation route, chosen as the candidate that minimizes or optimizes the evaluation metrics under constraints, and stores its sequence of positions and metrics in the information storage unit.

### Step 7:

The server generates route data and explanatory information for transmission.

The server, as input, uses the optimal evacuation route (sequence of positions and associated metrics), the selected refuge facility information, and the response information from the generative AI model. The server converts the sequence of positions into a compact representation, such as an ordered list of coordinates or an encoded polyline, and generates guidance instructions for each segment (for example, “go straight for 150 meters” or “turn right at the intersection”). The server also constructs explanatory information that combines the generative model's natural language explanation with explicit references to risk index values, facility capacity, and route constraints. The server outputs route data comprising position sequence, guidance instructions, and explanatory information, and the server prepares a response message for the terminal.

### Step 8:

The terminal transmits user context and receives route data.

The terminal, as input, obtains user position information from a location sensor and optionally receives a natural-language request from the user via a user interface. The terminal packages this information into a request message and transmits it to the server over a network connection. The terminal then waits for a server response. The terminal, as output of this step, receives the route data and explanatory information sent from the server, and stores them in local memory for immediate display and guidance.

### Step 9:

The terminal renders the evacuation route and provides guidance to the user.

The terminal, as input, uses the route data received from the server, including the sequence of positions, guidance instructions, and explanatory information. The terminal calls a mapping component to convert the sequence of positions into graphical polylines, draws these polylines on the display, and places markers at the user's current position and at the refuge facility location. The terminal displays textual guidance instructions and explanatory information in an overlay or panel. The terminal may also invoke a text-to-speech function to convert guidance instructions and explanatory information into audio output. The terminal outputs a visual and/or audio representation of the evacuation route, thereby assisting the user in following the computed path.

### Step 10:

The user initiates and interacts with the evacuation support process.

The user, as input provider, launches an application on the terminal and grants permission for location access when prompted. The user optionally enters or dictates a natural-language prompt sentence expressing the current situation and a request for an optimal evacuation shelter and route. For example, the user may input the following prompt sentence: “Currently, I am in Shibuya Ward, Tokyo. An earthquake has occurred. The epicenter is in Kanagawa Prefecture, the magnitude is 7.0, and the depth is 10 km. Please tell me the optimal evacuation shelter and evacuation route, and explain why this shelter and route are recommended.” The user's input triggers the terminal to send context data to the server, and the user later receives and follows the guidance and explanations displayed and spoken by the terminal as output of the prior steps.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional evacuation support systems for seismic disasters typically rely on fixed rule sets, static hazard maps, and precomputed route tables executed by general-purpose processors. These systems suffer from several technical limitations in terms of computer technology itself.

First, conventional systems lack a unified data processing pipeline that can dynamically integrate heterogeneous real-time data streams, such as geophysical sensor outputs, spatiotemporal earthquake parameters, geographic information, and traffic-state feeds. As a result, the systems often perform fragmented computations at different layers, causing redundant data transfers, high processing latency, and inefficient utilization of processor and memory resources when risk levels and routes must be frequently updated.

Second, while generative AI models have become available as powerful information processing tools, conventional evacuation support architectures do not exploit such models in a structured, machine-oriented way. Typical approaches either omit generative AI processing entirely or treat it as a mere front-end question-answering module. They do not generate machine-structured prompt sentences that encode detailed, fused sensor and map data, nor do they feed back the generative model's natural-language outputs into a deterministic routing and control pipeline. Consequently, the processor cannot systematically use the generative model to improve internal decision quality, reduce computation on the terminal side, or increase robustness of the overall processing flow.

Third, conventional systems do not closely couple server-side risk computation, prompt sentence generation, and autonomous vehicle control into a coordinated architecture. The absence of a processor-controlled loop that (i) computes area-based risk levels, (ii) computes accessibility indices of refuge facilities, (iii) generates optimized prompt sentences to a generative AI model, and (iv) converts the natural-language results into machine-readable route information for both user terminals and autonomous mobile units, leads to suboptimal route recomputation, duplicated pathfinding logic, and increased communication overhead. In particular, the autonomous mobile unit often performs its own independent route planning with limited access to integrated hazard data, which leads to inconsistent route selection, higher processor load in the vehicle, and degraded responsiveness in dynamically changing disaster environments.

Fourth, the interaction between server and user terminal in conventional systems is usually based on fixed-format messages and pre-defined user interfaces. There is no technical mechanism to systematically convert complex, multi-source, real-time hazard and traffic data into context-aware prompt sentences that are optimized for a generative AI model, nor to convert the model's natural-language recommendations back into compact route information suitable for constrained mobile processors. This lack of structured mediation results in inefficient use of network bandwidth, unnecessary terminal-side computation, and increased latency for users in mobile networks with limited throughput.

Accordingly, there is a need for an improved computer-implemented system and server architecture that (i) efficiently integrates multi-source disaster and mobility data, (ii) generates and processes structured prompt sentences for a generative AI model as part of the core computation pipeline, (iii) automatically derives optimized route information for both user terminals and autonomous mobile units from the model's natural-language outputs, and (iv) thereby improves processing efficiency, reduces redundant computation, and enhances responsiveness and consistency of evacuation guidance under seismic disaster conditions.

The specific processing by the specific processing unit 290 of the data processing device 12 in Application Example 1 is realized by the following means.

The present invention provides a server comprising a processor configured to acquire, from at least one geophysical observation apparatus and at least one information storage apparatus, disaster information including spatiotemporal earthquake parameters; associate position information, area information, and spatial information to calculate a risk level for each area; acquire candidate refuge facility information and movement path information from at least one geographic information providing apparatus and at least one mobile body information providing apparatus, and integrate the area-based risk level with the candidate refuge facility information and the movement path information to calculate an accessibility index for each candidate refuge facility; generate a prompt sentence including, as input data for a generative AI model, the disaster information, the area-based risk level, the candidate refuge facility information, and the movement path information; input the prompt sentence to the generative AI model and obtain, from the generative AI model, a natural-language risk evaluation result and a candidate refuge facility evaluation result; determine, based on the natural-language risk evaluation result and the candidate refuge facility evaluation result, a candidate of an optimal refuge facility and a movement route; convert the candidate of the optimal refuge facility and the movement route into machine-readable route information; and transmit the route information to a user terminal and to an autonomous mobile unit. This enables the server to implement a technically improved, integrated computation pipeline that offloads complex multi-source data fusion and decision logic from resource-constrained terminals and vehicles, uses the generative AI model as a structured co-processor via optimized prompt sentences, and produces consistent, low-latency route information for both user terminals and autonomous mobile units, thereby enhancing processing efficiency, reducing redundant computation, and improving responsiveness and robustness of evacuation guidance in dynamic seismic disaster environments.

The term “disaster information” refers to information indicating the occurrence, characteristics, and evolution of a hazardous event, including but not limited to physical parameters of an earthquake such as magnitude, location, depth, occurrence time, and elapsed time after occurrence, as well as related sensor and observational data.

The term “geophysical observation apparatus” refers to a hardware device configured to sense physical phenomena of the earth, such as seismic waves, ground acceleration, or ground displacement, and to output corresponding measurement data in an electronic format.

The term “information storage apparatus” refers to a hardware and software combination, such as a database system or storage server, that is configured to store, manage, and provide access to disaster-related data and other environmental or geographic data.

The term “position information” refers to data indicating a geographic location of an object or a user, typically represented by coordinates such as latitude and longitude or by an equivalent spatial representation.

The term “area information” refers to data that identifies or describes a geographic region, including but not limited to administrative areas, grid cells, or other predefined spatial units, and may include boundaries, identifiers, and associated attributes.

The term “spatial information” refers to data representing geometric or topological relationships in space, including positions, shapes, distances, and spatial relationships among regions, facilities, and routes.

The term “risk level” refers to a quantitative or qualitative measure that expresses a degree of hazard or danger for a given area, computed from disaster information and related parameters, and represented, for example, as a numerical score or as a discrete category.

The term “candidate refuge facility” refers to a physical facility that can be used as a shelter or evacuation destination during a disaster and that is considered as a potential target for evacuation route planning.

The term “candidate refuge facility information” refers to data describing one or more candidate refuge facilities, including but not limited to their locations, capacities, available equipment, accessibility characteristics, and current or estimated occupancy.

The term “movement path information” refers to data describing possible routes or paths between locations, including but not limited to road segments, intersections, travel directions, distances, estimated travel times, and associated constraints.

The term “geographic information providing apparatus” refers to a system or service configured to provide geographic data, such as map data, road networks, facility locations, and related spatial attributes, typically through an electronic interface.

The term “mobile body information providing apparatus” refers to a system or service configured to provide information related to mobile entities and transportation, including but not limited to traffic conditions, road status, congestion levels, and movement-related constraints.

The term “accessibility index” refers to a computed indicator that quantitatively represents an ease or difficulty of reaching a candidate refuge facility from one or more areas, based on at least risk levels, movement path information, and facility-related constraints.

The term “prompt sentence” refers to a structured natural-language or machine-readable text string that encodes input data and instructions and is provided as an input to a generative AI model to cause the model to generate a corresponding output.

The term “generative AI model” refers to an information processing system, typically implemented by a trained machine learning or neural network model, that is configured to generate output data such as natural-language text based on an input prompt sentence and internal parameters.

The term “natural-language risk evaluation result” refers to an output generated by a generative AI model, expressed in human-readable language, that describes or assesses a degree of risk for one or more areas based on supplied input data.

The term “candidate refuge facility evaluation result” refers to an output generated by a generative AI model, expressed in human-readable language, that evaluates or ranks one or more candidate refuge facilities with respect to safety, accessibility, or suitability.

The term “optimal refuge facility” refers to a refuge facility selected by the processor as the most suitable evacuation destination among multiple candidate refuge facilities, based on one or more criteria such as risk level, accessibility index, travel time, and user constraints.

The term “movement route” refers to a sequence of positions, segments, or instructions that defines a path for traveling from an origin, such as a user's current location, to a destination, such as a refuge facility.

The term “route information” refers to machine-readable data derived from a movement route, including but not limited to ordered waypoints, path geometry, and associated metadata used for navigation and guidance by a user terminal or an autonomous mobile unit.

The term “user terminal” refers to an electronic device operated by or associated with a user, such as a mobile communication device, computing device, or display device, configured to communicate with the server and present route information and guidance to the user.

The term “positioning apparatus” refers to a hardware and software configuration within or connected to a user terminal that is configured to determine a current geographic position of the user terminal, using, for example, satellite positioning, wireless signals, or sensor fusion.

The term “display apparatus” refers to a component of the user terminal that is configured to visually present information, including maps, route information, refuge facility information, and guidance instructions, to the user.

The term “sequential action instructions” refers to step-by-step guidance information, in textual, graphical, or audio form, that instructs a user on successive actions or movements to follow along a guidance route.

The term “autonomous mobile unit” refers to a mobile platform, such as a vehicle or robot, that is configured to move without continuous human driving input, based on route information and sensor-derived environmental data.

The term “onboard measurement apparatus” refers to one or more sensors and associated processing components mounted on an autonomous mobile unit and configured to detect surrounding-environment information, such as obstacles, road conditions, or traffic participants.

The term “surrounding-environment information” refers to data describing the environment around a user or an autonomous mobile unit, including obstacles, road states, traffic participants, and other factors relevant to safe movement or navigation.

In one embodiment, a server, a terminal, and an autonomous mobile unit cooperate to implement the invention. The server includes at least one processor, a memory device, and a communication interface. The terminal includes at least one processor, a display apparatus, a positioning apparatus, and a communication interface. The autonomous mobile unit includes at least one processor, an onboard measurement apparatus, a drive control apparatus, and a communication interface. The server, the terminal, and the autonomous mobile unit are interconnected via a wired or wireless network such as a cellular network, a wireless local network, or a wide area network. The server executes a software stack that may be implemented on a general-purpose operating system such as a Unix-like operating system. The server executes an application framework such as a web application framework written in a high-level programming language. The server provides application programming interfaces (APIs) to the terminal and to the autonomous mobile unit. The APIs exchange data structures defined in a structured format such as JavaScript Object Notation (JSON) or an equivalent structured text format.

The server uses a geophysical observation apparatus, such as a seismic sensor network, and an information storage apparatus, such as a relational database system, to obtain disaster information. The disaster information includes earthquake magnitude, hypocenter location, hypocenter depth, occurrence time, and elapsed time after occurrence. The server stores the disaster information in records of a database table having fields for each parameter, and may use a spatial extension to represent geographic coordinates and regions.

The server associates position information, area information, and spatial information to calculate a risk level for each area. The server maintains area information as polygonal regions or cells in a spatial index. The server calculates a distance between a hypocenter and a centroid of each area by executing a spatial distance function. The server then computes a numerical risk score, for example on a scale from 0 to 100, using an algorithm that combines magnitude, depth, distance, and elapsed time according to predefined coefficients stored in the memory device. The server may additionally apply temporal decay to the risk score as the elapsed time increases. The server converts the numerical risk score to a discrete risk level such as low, medium, or high. The server stores the risk score and risk level for each area in a database table linked to the corresponding area information.

The server acquires candidate refuge facility information and movement path information from a geographic information providing apparatus and a mobile body information providing apparatus.

The geographic information providing apparatus supplies map data, road network data, and facility locations. The mobile body information providing apparatus supplies real-time traffic-state data, road status information, congestion levels, and hazard flags. The server receives this information via the communication interface, parses the structured data, and stores it in tables representing nodes, edges, and attributes of a road network, as well as records representing candidate refuge facilities.

The server calculates an accessibility index for each candidate refuge facility. The server retrieves road network segments that connect an area to a candidate refuge facility, and evaluates path cost by combining travel distance, estimated travel time, congestion level, blocked segment penalties, and the risk level of areas through which the path passes. The server implements this calculation using a modified shortest-path algorithm, such as a weighted Dijkstra algorithm or A* algorithm, in which the edge weight includes both physical metrics (distance and time) and hazard metrics (risk and status). The server thereby obtains a minimum-cost path value for each candidate refuge facility and converts that value into an accessibility index normalized to a predetermined scale. The server stores the accessibility indices and related metrics in the database.

The server generates a prompt sentence as an input to a generative AI model. The generative AI model is implemented by a trained neural network model, such as a transformer-based language model, stored in the memory device of the server or accessible via a model providing apparatus through the communication interface. The server constructs the prompt sentence in natural language, but with embedded structured descriptions of disaster information, area-based risk levels, candidate refuge facilities, and movement path information. The server arranges these data items using a predetermined template that emphasizes attributes relevant to risk and evacuation decisions. The prompt sentence may be, for example:
“Context:
   An earthquake has occurred with magnitude 6.5 and depth 30 km. The epicenter is near a densely populated urban area. The regional risk level for Area X is High.
Available shelters:
   Shelter A: distance 0.8 km, estimated 7 minutes on foot, sufficient capacity, roads are open, low congestion.
   Shelter B: distance 1.2 km, estimated 12 minutes on foot, one main road partially blocked, medium congestion.
   Shelter C: distance 1.5 km, estimated 15 minutes on foot, wide roads, very low congestion.
Task:
   Considering safety, travel time, and road status, select the safest and most practical shelter for a person currently in Area X and explain the reasoning and a step-by-step route in simple language.”

The server inputs the prompt sentence to the generative AI model. The generative AI model uses an internal representation of tokens and attention weights to generate a natural-language risk evaluation result and a candidate refuge facility evaluation result. In one embodiment, the generative AI model is a multi-layer transformer network including an embedding layer, multiple self-attention layers, feed-forward layers, and a final linear output layer. The model has been trained on a training dataset including textual descriptions of hazards, evacuations, and routing scenarios, with supervised fine-tuning to align model outputs with desired evaluation criteria. The training process uses a loss function such as cross-entropy loss on next-token prediction or sequence-to-sequence loss, and updates model parameters by stochastic gradient descent with backpropagation. The training may also use data augmentation, such as paraphrasing and scenario perturbation, to increase robustness for varied disaster contexts.

The server receives, from the generative AI model, the natural-language risk evaluation result and the candidate refuge facility evaluation result. The server applies a deterministic parsing module to extract key decisions and justifications from the generated text. For example, the server identifies which one of the candidate refuge facilities is designated as preferred, the reasons citing low risk areas or open roads, and any explicit references to avoiding certain hazards. The server uses pattern matching rules or a shallow semantic parser to map phrases in the evaluation result back to structured decisions. Because the server constrains the prompt sentence structure and the vocabulary used to describe facilities and paths, this extraction process is deterministic and machine-implementable rather than relying on human interpretation.

The server determines a candidate of an optimal refuge facility and a movement route based on the evaluation result and the previously computed accessibility indices. The server may, for example, give priority to a refuge facility that the generative AI model explicitly recommends, but reject that recommendation if the associated accessibility index exceeds a predefined threshold. This combination of generative evaluation and deterministic constraint checking forms a non-conventional hybrid decision procedure, in which the generative AI model supplies high-level reasoning under uncertainty, and the server enforces safety and feasibility constraints using exact numerical computation. This hybrid procedure improves technical performance by reducing cases where a purely rule-based system would fail under incomplete or noisy data, while preventing arbitrary outputs from the generative AI model from degrading route safety.

The server converts the candidate of the optimal refuge facility and the movement route into route information. Route information is encoded as a sequence of waypoints, segment identifiers, and recommended maneuvers, along with metadata such as expected travel time and hazard annotations. The server compresses the route information using a compact polyline or equivalent encoding to reduce communication load. The server transmits the route information to the terminal and to the autonomous mobile unit via the communication interface. By performing the majority of the route computation and decision logic at the server, the system reduces processing load and memory consumption on the terminal and the autonomous mobile unit. This leads to improved processing speed and reduced energy consumption on resource-constrained devices.

The terminal executes an application on its processor to receive and utilize the route information. The terminal uses a positioning apparatus, such as a satellite-based positioning module or a hybrid positioning module, to obtain the current position of the user. The terminal calculates a relative position of the user on or near the provided route by comparing the current position to waypoints in the route information. The terminal then draws a guidance route on the display apparatus using a map rendering library. The terminal presents sequential action instructions derived from individual segments of the route information, such as “Walk straight for 200 meters, then turn left at the second intersection.” The terminal may also display risk-related annotations, such as “Avoid narrow alley on the right side due to higher debris risk,” which the terminal obtains from metadata in the route information.

The terminal may further send a prompt sentence to the generative AI model when the user explicitly requests natural-language guidance. For example, the user may input the following prompt sentence via a user interface:
“An earthquake has occurred. My current location is in the central district of the city. Please tell me the optimal evacuation route and the best shelter considering real-time traffic and road conditions.”

The terminal then enriches this user-provided prompt sentence with structured context retrieved from the server, including the current risk level, candidate refuge facilities, and the route already selected by the server. The terminal sends the enriched prompt sentence to the generative AI model and receives a detailed, user-friendly description of the route. The terminal displays this description and may convert it to audio using a text-to-speech engine. This arrangement allows the terminal to offload heavy reasoning and language generation to the server-side or model-side computation while utilizing minimal local resources.

The autonomous mobile unit receives the route information via its communication interface. The autonomous mobile unit uses its onboard measurement apparatus, which may include sensors such as cameras, radars, lidars, and inertial sensors, to detect surrounding-environment information. The autonomous mobile unit compares sensor-detected obstacles, road markings, and traffic participants to the expected conditions embedded in the route information. When the autonomous mobile unit detects significant deviation, such as a blocked roadway not indicated in the route information, the autonomous mobile unit sends an update request to the server, including a description of the new obstruction. The server then updates the movement path information and may generate a new route by repeating the risk and accessibility calculations, and by generating a new prompt sentence and receiving a new evaluation result from the generative AI model. The server transmits updated route information to the autonomous mobile unit. The autonomous mobile unit uses this updated route information to correct its travel path and transport the user to the refuge facility with fewer delays and safer maneuvering than a system that relies solely on onboard computation.

This architecture yields several technical improvements over conventional systems. Because the server aggregates multi-source disaster, geographic, and traffic data into normalized data structures, the server avoids redundant data transformations at the terminal and the autonomous mobile unit. The computationally intensive tasks, such as computing area-based risk levels, shortest paths with hazard-aware weights, and generating and parsing prompt sentences, are centralized at the server where more computing resources are available. As a result, the terminal and autonomous mobile unit can perform their local tasks more quickly and with lower memory usage, improving response time and reliability under network constraints.

In addition, the structured use of the generative AI model improves the quality of evacuation guidance and the robustness of the system. The server uses specific feature vectors—such as area risk scores, accessibility indices, route hazard flags, and facility attributes—as content of the prompt sentences. The generative AI model thus receives a richer, machine-curated input than a conventional free-form question. The generative AI model, via its deep neural network architecture, evaluates trade-offs among multiple factors that would be difficult to encode fully in hand-written rules. Because the server uses pre-defined templates and semantic parsing to process the output, the overall system implements a reproducible computational pipeline rather than a black-box interface. This pipeline reduces error rates in facility selection and route choice compared to either purely rule-based methods or naïve generative methods.

Furthermore, the invention is not limited to merely automating a human mental process. The server uses specific routing algorithms and data structures that enable non-conventional weighting of disaster risk and traffic conditions; this produces routes that prioritize safety and reachability under dynamic hazard conditions. The compressive encoding of route information and summarized risk data reduces the volume of data transmitted over the network, thereby reducing communication load and improving throughput in congested or degraded network environments. The server may also maintain cached intermediate calculations, such as precomputed risk grids or partially evaluated path trees, enabling faster recalculation when new disaster information arrives. These caching and incremental update strategies further reduce computation time and latency.

The invention is applicable to multiple implementation variations. In one variation, the generative AI model executes on the server itself. In another variation, the generative AI model executes on a remote model providing apparatus operated by a separate computing infrastructure, and the server communicates with that apparatus via a secure network. In yet another variation, a smaller generative AI model executes locally on the terminal, using a subset of context data if connectivity to the server is temporarily unavailable. In each variation, the server or terminal uses a consistent scheme of prompt sentence construction and structured parsing so that outputs from different instances or sizes of generative AI models can be integrated into the same decision logic.

The server may also adapt the structure of the prompt sentence based on the type of disaster or the accuracy required. For example, when the server detects a very high risk level, the server may generate a concise prompt sentence focusing on safety-critical constraints, such as avoiding bridges and tunnels, while omitting less essential information. When the risk level is moderate, the server may include more detailed options, such as trade-offs between travel time and comfort. This adaptive prompt design results in more efficient utilization of the generative AI model's computation and provides more focused outputs, thereby improving computational efficiency and guidance quality.

Through these configurations, the system leverages a combination of deterministic algorithms and generative AI processing to improve the underlying computer technology for disaster-related route planning. The server, the terminal, and the autonomous mobile unit cooperate to achieve improved processing speed, higher accuracy of route selection, reduced network and processor load on mobile components, and enhanced safety and reliability in real-world seismic disaster scenarios.

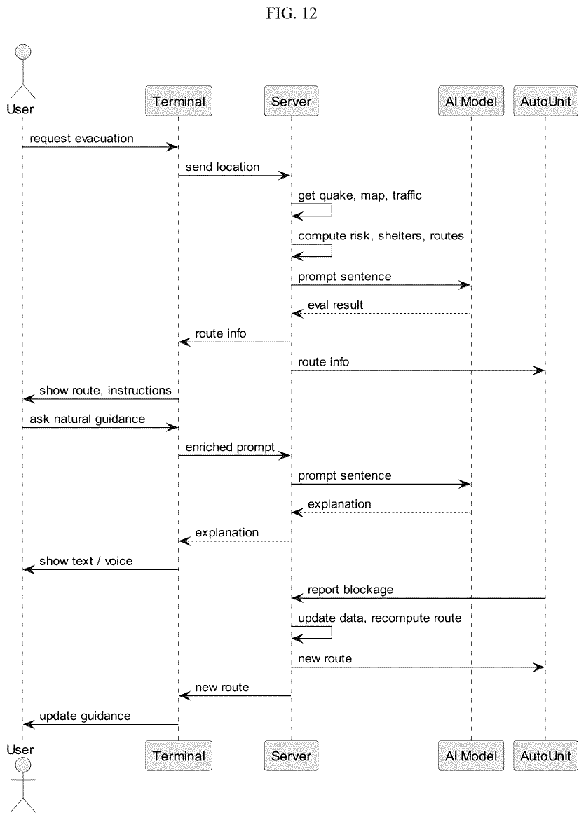

The following describes the processing flow using FIG. 12.

### Step 1:

Server acquires disaster information.

Server receives, as input, raw seismic measurements and stored event records from at least one geophysical observation apparatus and at least one information storage apparatus. Server parses these inputs to extract earthquake parameters such as magnitude, hypocenter coordinates, depth, occurrence time, and elapsed time. Server performs data validation (for example, range checks and timestamp consistency) and converts the various formats into a unified internal record structure. Server outputs normalized disaster information records stored in a database table and cached in working memory for subsequent processing.

### Step 2:

Server calculates an area-based risk level.

Server receives, as input, the normalized disaster information records and area information including geographic polygons and centroids of multiple regions. Server executes spatial distance computations between the hypocenter coordinates and each area centroid, and then applies a risk calculation algorithm that combines magnitude, depth, distance, and elapsed time using weighted arithmetic operations and temporal decay functions. Server outputs, for each area, a numerical risk score and a discrete risk level, and stores these outputs in an area-risk table linked to the corresponding area identifiers.

### Step 3:

Server acquires candidate refuge facility information.

Server receives, as input, queries specifying one or more target areas and calls a geographic information providing apparatus to obtain facility-related data. Server collects facility locations, capacities, facility types, and accessibility attributes from structured responses. Server performs data normalization by mapping heterogeneous attribute names to a standard schema and removing duplicates based on geographic proximity and identifiers. Server outputs a set of candidate refuge facility records associated with each area, and stores these records in a facility table for later use.

### Step 4:

Server acquires movement path and traffic information.

Server receives, as input, the target areas and the locations of candidate refuge facilities, and calls a mobile body information providing apparatus to obtain road network data, road status information, and traffic condition data. Server parses the responses to build or update a graph representation of the road network, where nodes represent intersections or waypoints and edges represent road segments with attributes such as length, speed limit, congestion level, and closure status. Server outputs an updated road network graph and a set of road status records that reflect current movement path conditions.

### Step 5:

Server calculates an accessibility index for each candidate refuge facility.

Server receives, as input, the area-based risk levels, the road network graph, and the candidate refuge facility records. Server executes a pathfinding algorithm, such as a weighted Dijkstra or A* algorithm, from representative points in each area to each candidate refuge facility, using edge weights that combine distance, travel time, congestion, and hazard penalties derived from risk levels and closure status. Server computes, for each candidate refuge facility, a minimum-cost path value and converts this value into an accessibility index using normalization and thresholding operations. Server outputs, for every facility, an accessibility index and associated path summary data, and stores these outputs in a facility-accessibility table.

### Step 6:

Server constructs a prompt sentence for a generative AI model.

Server receives, as input, the normalized disaster information, the area-based risk levels, the candidate refuge facility information, and the accessibility indices. Server applies a template-based text generation procedure to embed these structured data items into a natural-language description, including a context section, a list of candidate facilities with distances and risks, and explicit instructions for evaluation. Server concatenates the generated segments into a single prompt sentence that conforms to a pre-defined structure tailored to the generative AI model. Server outputs the prompt sentence as a text string ready for submission to the generative AI model.

### Step 7:

Server submits the prompt sentence to the generative AI model and obtains evaluation results.

Server receives, as input, the constructed prompt sentence and forwards it to the generative AI model via a model access interface. Server triggers the generative AI model to perform tokenization, multi-layer attention, and sequence generation processing based on the supplied prompt sentence. Server receives, as output, a natural-language response that includes a risk evaluation result and a candidate refuge facility evaluation result, such as identification of preferred facilities and reasoning about safety and accessibility. Server stores this response text in memory for subsequent parsing and decision-making.

### Step 8:

Server parses the generative AI model output and selects an optimal refuge facility.

Server receives, as input, the natural-language response from the generative AI model and the structured facility-accessibility data. Server applies a deterministic parsing module that uses pattern matching and keyword detection to extract facility identifiers, qualitative risk assessments, and recommended strategies from the text. Server then cross-references the extracted facility identifiers with the accessibility indices and applies decision rules that may reject facilities whose indices exceed safety or time thresholds. Server outputs a selected optimal refuge facility identifier and associated decision metadata indicating reasons and constraints.

### Step 9:

Server generates a movement route to the optimal refuge facility.

Server receives, as input, the optimal refuge facility identifier, the road network graph, and area or user location information. Server executes a constrained shortest-path algorithm to compute a detailed path from the origin (for example, a region center or user location) to the optimal refuge facility, using edge weights that integrate travel time, distance, and risk-related penalties. Server refines the path by adding intermediate waypoints at intersections and critical turning points and assigns maneuver types (for example, go straight, turn left, avoid segment) to each step. Server outputs a movement route represented as an ordered list of waypoints and maneuvers.

### Step 10:

Server converts the movement route into compact route information and transmits it.

Server receives, as input, the movement route and the optimal refuge facility identifier. Server encodes the waypoints into a compact representation, such as a polyline-like encoding, and attaches metadata including expected travel time, cumulative distance, and hazard annotations. Server packages this data as route information tailored to both the terminal and the autonomous mobile unit, possibly using different levels of detail. Server outputs route information messages and transmits them over the network to the terminal and to the autonomous mobile unit.

### Step 11:

Terminal acquires the user's current position and aligns it with the route information.

Terminal receives, as input, the route information from the server and obtains current position data from the positioning apparatus. Terminal converts raw positioning data (latitude, longitude, accuracy) into a position object and projects this position onto the route geometry by locating the nearest route segment and computing a progress ratio along that segment. Terminal outputs an aligned position along the route and a current step index corresponding to the appropriate maneuver in the route information.

### Step 12:

Terminal displays the guidance route and presents sequential action instructions.

Terminal receives, as input, the route information and the aligned route position. Terminal renders a map view and overlays the guidance route as a highlighted path. Terminal selects the current and next maneuvers based on the step index and displays text instructions such as “Walk 200 meters straight ahead, then turn left at the intersection.” Terminal may also display icons or color-coded warnings for high-risk segments obtained from hazard annotations. Terminal outputs a dynamic user interface that continuously updates as new position data is obtained.

### Step 13:

User optionally issues a natural-language request for guidance.

User provides, as input, a natural-language query via an input interface on the terminal, for example: “An earthquake has occurred. My current location is in the central district. Please tell me the optimal evacuation route and the best shelter considering real-time traffic and road conditions.” User may further specify constraints, such as mobility limitations, in the same prompt sentence. User outputs the query to the terminal application for further processing.

### Step 14:

Terminal enriches the user prompt sentence and requests a generative AI explanation.

Terminal receives, as input, the user's prompt sentence, the route information, the optimal refuge facility information, and risk data retrieved from the server. Terminal appends structured context to the user's text in natural-language form, describing the selected shelter, estimated time, and any notable hazards. Terminal constructs an enriched prompt sentence that clearly indicates the user's situation and the already computed technical solution. Terminal outputs this enriched prompt sentence and sends it to the generative AI model via the server or a model access interface.

### Step 15:

Terminal receives and presents natural-language guidance from the generative AI model.

Terminal receives, as input, the generative AI model's natural-language response, which may include a narrative explanation of why a particular shelter is recommended and a human-friendly description of the route steps. Terminal parses the response to separate high-level explanation from step-by-step directions, and displays this content in a chat-style view or overlay on the map. Terminal may also convert the text into speech by invoking a text-to-speech function. Terminal outputs enhanced, user-friendly guidance without changing the underlying route information used for navigation.

### Step 16:

Autonomous mobile unit receives route information and plans motion.

Autonomous mobile unit receives, as input, the route information from the server. Autonomous mobile unit interprets the sequence of waypoints and maneuvers as a high-level path plan and converts each segment into a trajectory suitable for low-level control. Autonomous mobile unit uses its onboard measurement apparatus to detect current lane geometry, obstacles, and traffic participants, and fuses this sensor data with the high-level path using sensor fusion algorithms. Autonomous mobile unit outputs control commands to its drive control apparatus to follow the route while respecting safety margins.

### Step 17:

Autonomous mobile unit monitors deviations and requests route updates when necessary.

Autonomous mobile unit receives, as input, real-time sensor data and compares detected road closures or obstacles to the expected conditions indicated in the route information. Autonomous mobile unit detects deviations such as blocked intersections or unexpected hazards by analyzing sensor features and classifying anomalies. When a deviation is detected, autonomous mobile unit compiles a status report containing the current position, nature of the obstruction, and affected route segment, and transmits this report to the server. Autonomous mobile unit outputs a request for updated route information to maintain safe and efficient travel toward the refuge facility.

### Step 18:

Server updates path and route information in response to new hazards.

Server receives, as input, the status report from the autonomous mobile unit or from the terminal, indicating a new obstruction or condition change. Server updates the movement path and traffic information in the road network graph to reflect the newly blocked or degraded segments. Server recalculates paths and accessibility indices for affected routes by executing the pathfinding and risk-assessment algorithms again. Server may optionally generate a new prompt sentence and obtain a fresh evaluation from the generative AI model if the overall risk context has changed significantly. Server outputs revised route information and transmits it back to the terminal and the autonomous mobile unit to maintain an up-to-date and safe evacuation route.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional disaster response systems for seismic events typically rely on statically coded rules, precomputed hazard maps, and generic routing engines. Such systems suffer from several technical limitations when operating in highly dynamic environments. First, existing systems frequently process heterogeneous seismic data, traffic data, and facility data in separate software components without a unified representation, which causes inefficiencies in memory usage, increases inter-component latency, and prevents consistent end-to-end optimization. Second, many systems invoke route calculation services directly from user terminals, leading to redundant network requests, inconsistent use of traffic and road closure data, and increased processing load on resource-constrained terminal devices. Third, even when multiple data sources are utilized, conventional systems often lack a mechanism for automatically transforming structured hazard and routing data into coherent, context-aware natural language guidance, resulting in fragmented user interfaces that require additional client-side processing and manual integration of information.

Furthermore, prior techniques that merely apply a generative model to user-entered text do not exploit the generative model as part of a tightly integrated computational pipeline. In such approaches, the generative model typically receives only loosely structured prompts, so it cannot consistently leverage real-time hazard indices, structured evacuation facility attributes, and route-segment-level safety metrics. As a result, the generated guidance may be incomplete, inconsistent with the latest sensor or database state, or computationally redundant with existing server-side logic. This leads to increased processing time, unnecessary network traffic, and difficulties in scaling the system to large numbers of simultaneous users in a disaster scenario.

Accordingly, there is a need for a technical framework in which a server-side processor centrally acquires and aggregates seismic information, calculates a quantitative hazard index, dynamically selects and evaluates evacuation facilities and route candidates, and then constructs a structured representation that can be consumed by a generative model in a deterministic manner. There is also a need for improved processor-level workflows and data structures that reduce redundant computation across seismic evaluation, evacuation facility selection, route optimization, and natural language explanation generation, thereby improving end-to-end response latency, consistency of the generated instructions, and robustness of the system under high load conditions. The present invention addresses these technical problems by providing an integrated server architecture and processing method that tightly couples hazard evaluation, route optimization, and generative-model-based explanation in a unified computational pipeline.

The specific processing by the specific processing unit 290 of the data processing device 12 in Example 2 is realized by the following means.

The present invention provides a server comprising a processor configured to acquire seismic-related information from at least one external information providing apparatus, read the seismic-related information from an information storage apparatus that stores the seismic-related information, execute an evaluation algorithm that calculates a hazard index using the seismic-related information as input, generate information acquisition conditions for acquiring evacuation facility information based on the hazard index and position information, acquire the evacuation facility information from at least one public information providing apparatus or at least one local-government information providing apparatus, acquire current position information from a position information acquisition apparatus, transmit a route search request including the current position information and the evacuation facility information to a route search information providing apparatus and acquire route candidate information including traffic condition information and road passability information, calculate a safety index and a required-time index for the route candidate information and specify an optimal evacuation route based on the safety index and the required-time index, generate structured data including the hazard index, the evacuation facility information, and the optimal evacuation route, generate a prompt sentence including the structured data and input the prompt sentence to a generative information processing model to acquire a natural language explanation sentence, and transmit the optimal evacuation route and the explanation sentence to a terminal apparatus including a user display apparatus and a voice output apparatus. This enables centralized and optimized processing of heterogeneous disaster-related data on the server side, reduces redundant computation and communication between client and server, and allows the generative information processing model to produce consistent, context-aware natural language guidance directly from structured hazard and routing data, thereby improving the technical performance, scalability, and responsiveness of computer-implemented disaster response systems.

The term “processor” refers to a hardware data processing unit, such as a central processing unit or an equivalent processing circuitry, configured to execute instructions and perform arithmetic and logical operations on data.

The term “seismic-related information” refers to measurement data and event data associated with a seismic phenomenon, including at least magnitude information, hypocenter position information, hypocenter depth information, seismic event occurrence time information, and elapsed-time information after the seismic event.

The term “external information providing apparatus” refers to an information processing system, separate from the server, that provides seismic-related information via a communication network according to a request from the processor.

The term “information storage apparatus” refers to a storage device or storage subsystem, such as a database system or non-volatile memory, configured to store and provide seismic-related information or other disaster-related information to the processor.

The term “evaluation algorithm” refers to a sequence of computational operations, implemented as executable instructions, that receives seismic-related information as input and outputs a numerical value representing a hazard index.

The term “hazard index” refers to a quantitative indicator, represented by a numerical value, that expresses a degree of risk associated with a seismic event for a particular region or location.

The term “position information” refers to data indicating a geographic location, including at least coordinate information such as latitude and longitude.

The term “information acquisition conditions” refers to parameters, constraints, or query items, generated by the processor, that are used to specify which evacuation facility information is to be obtained from an information providing apparatus.

The term “evacuation facility information” refers to data describing an evacuation facility, including at least a facility position, a capacity, and one or more facility attributes such as available equipment or accessibility features.

The term “public information providing apparatus” refers to an information processing system operated by a public entity and configured to provide evacuation facility information or other disaster-related information via a communication network.

The term “local-government information providing apparatus” refers to an information processing system operated by a local administrative entity and configured to provide evacuation facility information or other regional disaster-related information via a communication network.

The term “current position information” refers to position information that represents a present or recent geographic location of a user or a terminal apparatus.

The term “position information acquisition apparatus” refers to a device or subsystem, such as a satellite positioning receiver or a location service module, configured to acquire current position information.

The term “route search request” refers to a message generated by the processor and transmitted to a route search information providing apparatus, the message including at least current position information and evacuation facility information as input conditions for route calculation.

The term “route search information providing apparatus” refers to an information processing system configured to receive a route search request and provide route candidate information, including traffic condition information and road passability information, via a communication network.

The term “route candidate information” refers to data representing one or more candidate routes between an origin and a destination, including at least route geometry, traffic condition information, and road passability information.

The term “traffic condition information” refers to data indicating a state of traffic along a road segment or route, including at least congestion information, average speed information, or delay information.

The term “road passability information” refers to data indicating whether a road or a road segment is usable, restricted, or closed, due to factors such as damage, obstruction, or regulation.

The term “safety index” refers to a numerical indicator that expresses a degree of safety of a route or route segment, calculated on the basis of route candidate information including at least road passability information and, optionally, hazard-related information.

The term “required-time index” refers to a numerical indicator that expresses an estimated travel time required to traverse a route or route segment under given traffic conditions.

The term “optimal evacuation route” refers to a route selected from among route candidates by evaluating at least the safety index and the required-time index according to a predetermined optimization criterion.

The term “structured data” refers to data organized according to a predefined schema or format, including at least fields representing the hazard index, evacuation facility information, and optimal evacuation route, and suitable for programmatic processing.

The term “prompt sentence” refers to a text sequence generated by the processor that includes at least part of the structured data and that is formatted as an input instruction for a generative information processing model.

The term “generative information processing model” refers to a trained computational model, such as a generative artificial intelligence model, configured to receive a prompt sentence as input and generate a natural language explanation sentence as output.

The term “natural language explanation sentence” refers to one or more sentences expressed in a human language, generated by the generative information processing model, and describing at least a hazard situation, evacuation facility information, or an optimal evacuation route.

The term “terminal apparatus” refers to an information processing device used by a user, such as a portable communication device or a computing terminal, configured to communicate with the server and present information to the user.

The term “user display apparatus” refers to a display unit included in the terminal apparatus, configured to visually present the optimal evacuation route, evacuation facility information, or the natural language explanation sentence to the user.

The term “voice output apparatus” refers to an audio output unit included in the terminal apparatus, configured to output a voice representation of at least part of the natural language explanation sentence or navigation instructions to the user.

In one embodiment, a server includes a processor, a main memory, a non-volatile memory, a network interface, and an interface to an external storage apparatus such as a database system. The server runs an operating system such as a UNIX-like operating system and executes application software implemented using a programming language such as a scripting language. The server communicates with one or more terminal devices over a communication network via the network interface.

A terminal includes a processor, a memory, a display unit, a voice output unit, a wireless communication unit, and a position information acquisition apparatus such as a satellite positioning receiver and an inertial sensor module. The terminal runs a mobile operating system such as a smartphone operating system and executes an application program that interacts with the server and presents information to a user.

A user operates the terminal to permit access to current position information and to request hazard evaluation and evacuation guidance. The user may additionally input textual queries that are converted into prompt sentences for a generative AI model running on or accessible by the server.

In one embodiment, the server is configured to realize the claimed functions by executing multiple software modules that implement data acquisition, hazard evaluation, facility selection, route optimization, and generative-model-driven explanation. The server stores program instructions and configuration data in the non-volatile memory and loads them into the main memory during operation.

The server uses an external information providing apparatus, such as a seismic information service, as a source of seismic-related information. The server uses a software library for HTTP communication (for example, a REST client library) to send requests to the external information providing apparatus and to receive responses in a structured data format such as JSON. The server parses the received data and stores normalized seismic-related information into the information storage apparatus, which may be implemented as a relational database system (for example, a database server using a structured query language).

The server uses an evaluation algorithm to calculate a hazard index from the seismic-related information. The evaluation algorithm may be implemented as a module that reads magnitude values, hypocenter coordinates, depth values, occurrence timestamps, and elapsed-time values for each seismic event, and computes a numerical hazard index according to a weighted function. The server may, for example, assign a first weight to magnitude, a second weight to distance between a hypocenter and a target region, and a third weight to depth, and compute a composite score as a linear or non-linear combination of these weighted features. The server may further apply time decay factors to reduce the influence of older events. Because the server performs this calculation on structured records stored in the database, the server can update hazard indices in near real time as new seismic events are stored.

The server uses the computed hazard index and position information to generate information acquisition conditions for evacuation facility information. The server may store a mapping from hazard index ranges to maximum allowable distance to an evacuation facility or to minimum facility capacity thresholds. The server uses these mappings to construct query conditions that specify location ranges, facility attributes, and capacity constraints. The server transmits these query conditions to public information providing apparatuses or local-government information providing apparatuses that expose evacuation facility data as open data or via application programming interfaces. The server then receives facility lists including positions, capacities, and attributes, and stores these data in the information storage apparatus in normalized tables such as facility, capacity, and attribute tables.

The terminal also may directly obtain evacuation facility information from a public information providing apparatus, convert it into a local data structure such as a local database table, and transmit a subset of the information to the server. In this case, the server aggregates server-side and terminal-side facility information into a unified set. This distributed acquisition improves robustness in case some information sources are temporarily unavailable.

The terminal uses the position information acquisition apparatus to obtain current position information of the user. The terminal accesses hardware such as a satellite positioning receiver and uses operating-system-level location services to obtain latitude, longitude, accuracy, and timestamp. The terminal stores the latest position information in memory and transmits it to the server through a secure communication channel, for example using HTTPS.

The server uses a route search information providing apparatus, such as a map and route computation service, to calculate route candidate information. The server constructs route search requests that include at least the current position information as the origin and one or more evacuation facility positions as destinations, and that may further include parameters specifying travel mode (for example, walking or driving), time of day, and constraints such as avoiding certain types of roads. The server sends the route search requests via an HTTP client library and receives route candidate information including route geometry, route-segment-level travel time estimates, traffic condition information, and road passability information.

The server calculates a safety index and a required-time index for each route candidate. The server may represent a route candidate as a sequence of route segments, each segment including attributes such as segment length, average travel time, congestion level, road type, and passability flag. The server calculates a segment-level safety score based on attributes such as passability, proximity to hazardous zones, or infrastructure vulnerability indicators. The server then aggregates segment-level safety scores into a route-level safety index, for example by computing a weighted sum where segments near hazardous structures are weighted more heavily. The server also aggregates segment-level travel times into a route-level required-time index. The server then applies an optimization criterion that trades off safety index and required-time index, for example by minimizing a composite metric that penalizes unsafe segments more strongly than increased travel time. Because the server performs these calculations on structured data with segment-level granularity, the server can avoid routes that are theoretically shortest but unsafe in disaster conditions.

The server generates structured data that includes at least the hazard index, evacuation facility information, and optimal evacuation route. The server may represent the structured data as a hierarchical object where top-level fields represent the target region, hazard indices, selected facilities, and selected route, and where subfields contain detailed attributes such as facility capacities, route segment coordinates, and safety scores. This structured representation is specifically designed to be consumed by a generative information processing model, so that the generative model receives unambiguous and pre-aggregated information instead of unstructured text.

In one embodiment, the server uses a generative AI model implemented as a transformer-based neural network. The generative AI model is trained as a sequence-to-sequence language model with attention mechanisms, using a training corpus that includes disaster-related texts, route descriptions, and structured-to-text transformation examples. The generative AI model comprises multiple encoder layers and decoder layers, each layer including multi-head self-attention modules and feed-forward networks. The server stores the model parameters, including weight matrices and bias vectors, in model storage, and loads them into memory when the generative AI model is executed. The generative AI model has been trained using an optimization algorithm such as stochastic gradient descent with adaptive learning rate, and uses a loss function such as a cross-entropy loss between predicted token distributions and reference tokens. The server maintains a tokenizer that converts prompt sentences into token sequences and a detokenizer that converts generated token sequences back into natural language text.

The server generates a prompt sentence by combining the structured data with natural language instructions. The server may, for instance, convert hazard index values into textual phrases, convert facility attributes into descriptive clauses, and embed route step data into enumerated instructions. The server then concatenates these textual segments into a prompt sentence that conforms to a predefined template. The server uses a prompt generator module that ensures consistent ordering and labeling of elements in the prompt, which allows the generative AI model to rely on stable contextual patterns.

An example of a prompt sentence that the server may generate and input to the generative AI model is:
“I am currently in Shibuya-ku, Tokyo. Using the following structured data, evaluate the earthquake-related hazard level and explain the safest evacuation route. Hazard index: high. Nearby shelters: Shelter A (capacity 300, barrier-free), Shelter B (capacity 150). Selected route: from current location to Shelter A, estimated time 12 minutes, avoids blocked roads. Please describe step-by-step walking instructions and provide safety-related comments.”

Another example of a prompt sentence that the server may accept from the user and extend with structured data is:
“I am currently in central Osaka. Assume that a strong earthquake has just occurred. Based on magnitude, epicenter, and depth, assess the hazard level for my location, select a suitable shelter considering capacity and facilities, and provide detailed walking directions that avoid dangerous roads.”

The server uses the tokenizer to convert the prompt sentence into token identifiers and feeds them into the generative AI model. The generative AI model computes attention scores over the token sequence, propagates activations through the transformer layers, and outputs probability distributions over possible next tokens at each generation step. The server samples or selects tokens according to a decoding strategy such as greedy selection or beam search, thereby generating a natural language explanation sentence. Because the generative AI model receives detailed structured data embedded in the prompt sentence, the generative AI model can output guidance that is aligned with the latest hazard indices and route decisions computed by the server.

The terminal receives the optimal evacuation route and the natural language explanation sentence from the server via the wireless communication unit. The terminal parses the route data and uses a map rendering library to display the route on a map together with markers representing the selected evacuation facilities. The terminal also displays textual hazard indicators and a summary of the explanation sentence. The terminal uses the voice output unit and a text-to-speech engine to read the explanation sentence aloud to the user, optionally segmenting the explanation sentence into stepwise navigation prompts that are synchronized with the user's movement.

The described configuration provides technical effects beyond a mere automation of human decision-making. Because the server centralizes seismic data acquisition, hazard index computation, facility selection, and route evaluation, the server reduces redundant computations that would otherwise be individually performed on multiple terminals. By encoding seismic data, facility attributes, and route metrics into specific structured data formats, the server reduces the size and complexity of data transmitted over the network. This leads to reduced communication load and improved response time, particularly when a large number of users concurrently request guidance.

The integration of the generative AI model with structured data also improves computation efficiency. The server does not require the generative AI model to perform complex numerical optimization or database searching; instead, the server performs these operations using specialized algorithms and passes only the aggregated results to the generative AI model. This division of labor allows the generative AI model to operate on shorter, semantically rich prompt sentences, which reduces the number of tokens per request and thus decreases computational load on the neural network. As a result, processing latency for generating explanations is reduced and throughput is improved.

The hazard evaluation algorithm and route optimization algorithm implemented by the server differ from conventional human heuristics. The server can evaluate many route candidates in parallel using vectorized operations over route segment attributes, and can apply non-intuitive weighting schemes that are tuned by simulation or by historical data. For example, the server may assign high penalties to segments with uncertain passability but only moderate penalties to segments with moderate congestion, recognizing that an impassable or damaged road is more critical than a delay. Humans often cannot reliably apply such multi-objective, data-driven weighting at scale, especially under time pressure. The server's algorithmic structure thus realizes technical improvements in route safety and travel time estimation accuracy.

The generative AI model also does not simply reproduce human-written instructions. Because the generative AI model is trained with structured-to-text mapping tasks, the generative AI model learns to attend to specific labels and values in the prompt sentence, such as hazard levels and facility capacities, and to reflect them consistently in the output. This differs from simple textual paraphrasing and amounts to a dedicated transformation from highly structured numeric and categorical data into coherent, context-appropriate natural language instructions. The model's architecture, including multi-head attention over the prompt tokens, allows the model to refer back to different parts of the structured data when generating different parts of the explanation, which improves consistency and reduces omission of critical information.

The combination of server-side structured computation and generative-model-based explanation yields a synergy that improves both accuracy and speed. Because the server uses deterministic hazard and route algorithms to derive base decisions, the system avoids arbitrary variations that would occur if a generative model alone were responsible for deciding routes. The generative AI model is then used to rephrase and structure the decisions into human-understandable language, which optimizes the user interface layer without sacrificing computational determinism at the core. This architecture improves end-to-end technical performance and is particularly suitable for high-load, time-critical environments such as disaster response.

In alternative embodiments, the server may use different machine learning models instead of a transformer-based model, such as a recurrent neural network with attention or a convolutional sequence model, provided that the model can receive prompt sentences and output natural language explanation sentences. The server may also store different structured data schemas for different disaster types and dynamically select a schema according to the type of event. The evaluation algorithm may be extended with additional features such as soil characteristics, building density, or sensor readings from distributed seismic devices. The route optimization module may incorporate multi-criteria optimization methods such as Pareto front analysis to better handle trade-offs between safety and speed.

In another embodiment, part of the evaluation algorithm or route scoring may be learned from data using supervised or reinforcement learning. The server may store historical trajectories, hazard outcomes, and user feedback and may train a secondary model that predicts route success probability or expected safety. The server can integrate such predicted metrics into the safety index and required-time index, further improving route selection quality. Training of such a model may use loss functions such as mean squared error for regression or cross-entropy for classification, and may use gradient-based optimization algorithms to update model parameters.

The described system thus provides a concrete technical implementation in which the server, the terminal, and the generative AI model cooperate through specific data structures, algorithms, and network protocols. The system improves processing speed, accuracy of hazard assessment and route selection, data management efficiency, and communication efficiency, and offers a robust, scalable foundation for computer-implemented disaster response that goes beyond abstract data processing or mere automation of human mental steps.

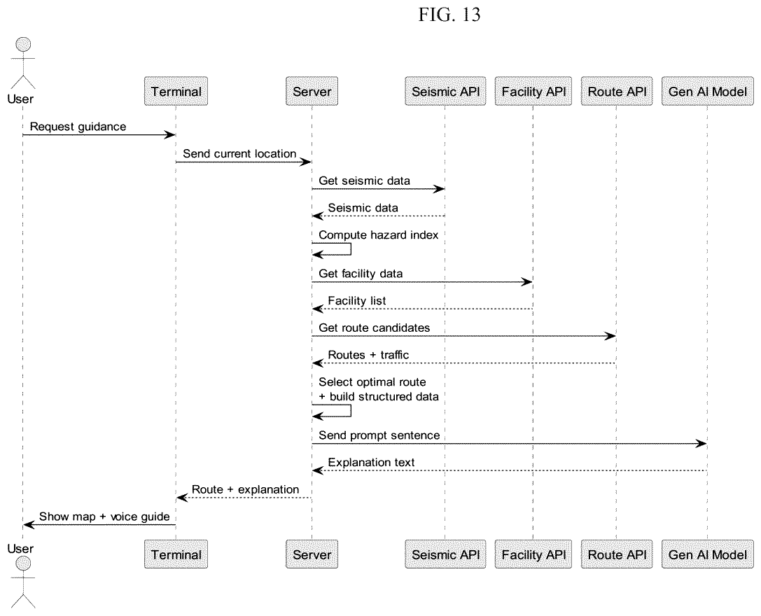

The following describes the processing flow using FIG. 13.

### Step 1:

Server acquires seismic-related information from an external information providing apparatus.

Server uses a network communication library to send a request message to the external apparatus and receives a response including at least magnitude, hypocenter coordinates, depth, occurrence time, and event identifier.

Input: None from previous internal steps; external seismic data provided by the external information providing apparatus.

Output: Raw seismic data records in a structured format (for example, a list of JSON objects) stored temporarily in server memory.

Server parses each record, validates numeric ranges and timestamp formats, and converts the records into normalized internal objects.

### Step 2:

Server stores the seismic-related information in an information storage apparatus.

Server executes database insert or update operations to write each normalized seismic event into a persistent table that includes fields for magnitude, latitude, longitude, depth, occurrence time, and region identifier.

Input: Normalized seismic data objects in server memory from Step 1.

Output: Persistent seismic event records stored in the information storage apparatus, indexed by region and time for efficient retrieval.

Server also updates auxiliary indexes such as region-based indices to accelerate later hazard evaluation queries.

### Step 3:

Server receives current position information from Terminal.

Terminal obtains the current geographic coordinates using a position information acquisition apparatus and transmits the coordinates, accuracy, and timestamp to Server over a network.

Input (Server side): Position message containing latitude, longitude, accuracy, and timestamp from Terminal.

Output: Stored current position information associated with a user session or terminal identifier in server memory.

Server optionally maps the coordinates to a region identifier using a geographic mapping function and stores the mapping result.

### Step 4:

Server retrieves relevant seismic-related information for the region corresponding to the current position.

Server executes a database query that selects seismic events within a specified time window and within a specified distance from the user's region or coordinates.

Input: Current position information (coordinates and region identifier) from Step 3 and persistent seismic event records from Step 2.

Output: A filtered set of seismic event records relevant to the user's area, held in server memory as a list or array.

Server may sort the events by occurrence time or magnitude to prepare them for hazard evaluation.

### Step 5:

Server calculates a hazard index for the user's region using an evaluation algorithm.

Server reads each seismic event record in the filtered set and computes intermediate features such as distance between hypocenter and user position, time decay factors since occurrence, and normalized magnitude and depth scores.

Input: Filtered seismic event records from Step 4.

Output: A numerical hazard index value (for example, a floating-point number in a predefined range) and an associated hazard category label (for example, low, medium, high).

Server applies a weighted combination of the intermediate features, for example by computing a sum of products between feature values and predefined weights, and then normalizes the result to a fixed scale. Server then assigns the hazard category by comparing the index with threshold values.

Step 6:

Server generates information acquisition conditions for evacuation facility information based on the hazard index and position information.

Server selects parameters such as maximum search radius, minimum facility capacity, and required facility attributes (for example, barrier-free or medical support) by referencing a configuration table parameterized by hazard category.

Input: Hazard index and hazard category from Step 5, and current position information from Step 3.

Output: A set of structured query conditions that specify geographic filters, capacity thresholds, and attribute constraints for evacuation facilities.

Server encapsulates these conditions in a request object that can be used to query public or local-government information providing apparatuses.

### Step 7:

Server acquires evacuation facility information from one or more external information providing apparatuses.

Server transmits the information acquisition conditions to the external apparatuses via network requests and receives facility lists that include positions, capacities, and facility attributes.

Input: Information acquisition conditions from Step 6 and external facility data sources.

Output: A set of evacuation facility records, each containing at least coordinates, capacity, and attributes, stored in server memory.

Server normalizes and stores these facility records in the information storage apparatus, linking them to the region and hazard index for later reference.

### Step 8:

Terminal optionally acquires additional evacuation facility information and shares it with Server.

Terminal sends its own requests to public or local-government sources using the same or similar conditions and receives facility data.

Input (Terminal side): Information acquisition conditions received from Server or derived from local settings.

Output (Terminal to Server): A subset of facility records transmitted to Server to complement server-side acquisition.

Server merges the facility records received from Terminal with its own records, removing duplicates and harmonizing attributes.

### Step 9:

Server selects candidate evacuation facilities for route computation.

Server filters the aggregated facility records using criteria such as distance from current position, facility capacity relative to estimated demand, and required attributes.

Input: Aggregated evacuation facility records from Steps 7 and 8, and current position information from Step 3.

Output: A reduced list of candidate facilities suitable for evacuation, each annotated with relevance scores or priorities.

Server may rank the candidates based on a scoring function that combines distance, capacity, and attribute suitability.

### Step 10:

Server constructs and transmits route search requests to a route search information providing apparatus.

Server encodes the current position as the origin and the candidate facility positions as destinations or waypoints, and includes parameters such as travel mode and avoidance preferences.

Input: Current position information from Step 3 and candidate evacuation facilities from Step 9.

Output: One or more route search requests transmitted to the route search information providing apparatus and pending responses.

Server may batch multiple destinations into a single request where the external apparatus supports it.

### Step 11:

Server acquires route candidate information including traffic condition information and road passability information.

Server receives response messages from the route search information providing apparatus that contain route polylines, segment lists, estimated travel times, congestion levels, and passability flags.

Input: Route search responses from the route search information providing apparatus corresponding to the requests of Step 10.

Output: A set of route candidate objects, each containing a sequence of route segments and associated attributes, stored in server memory.

Server may decode encoded polyline formats into explicit coordinate sequences for internal processing.

### Step 12:

Server calculates a safety index and a required-time index for each route candidate.

Server iterates over route segments of each candidate and computes segment-level safety scores based on road passability, proximity to hazard zones, and road type, and then aggregates these scores into a route-level safety index. Server also sums segment-level travel times to form a route-level required-time index.

Input: Route candidate objects from Step 11 and, optionally, hazard-related geospatial data linked to the current event.

Output: For each route candidate, a pair of indices consisting of a safety index and a required-time index stored alongside the route data.

Server may normalize safety and time indices to comparable scales and compute a composite evaluation metric.

### Step 13:

Server specifies an optimal evacuation route based on the safety index and the required-time index.

Server evaluates all route candidates using the composite evaluation metric and selects the route that optimizes the predefined trade-off between safety and speed.

Input: Route candidates and associated indices from Step 12.

Output: A single optimal evacuation route object, including its segments, geometry, safety index, and required-time index.

Server may also compute a backup route or secondary candidates according to alternative optimization criteria.

### Step 14:

Server generates structured data including the hazard index, evacuation facility information, and optimal evacuation route.

Server constructs a hierarchical data object with fields for hazard index and category, selected facility details, and detailed route segment information such as coordinates, step descriptions, segment safety scores, and segment times.

Input: Hazard index from Step 5, selected evacuation facility from Step 9, and optimal evacuation route from Step 13.

Output: A structured data object stored in server memory and suitable for both further programmatic processing and conversion into a prompt sentence.

Server ensures that field names and value formats conform to a predefined schema used by the prompt generation module.

### Step 15:

Server generates a prompt sentence based on the structured data and prepares input for the generative AI model.

Server converts numerical and categorical values in the structured data into descriptive phrases and embeds them into a natural language template that describes current hazard status, selected facilities, and route characteristics.

Input: Structured data object from Step 14.

Output: A prompt sentence in natural language text form that encodes the structured data content, ready for tokenization.

Server may, for example, create a prompt sentence that states the hazard index, lists nearby shelters with capacities, and summarizes the chosen route and reasons for selection.

### Step 16:

Server executes the generative AI model using the prompt sentence and generates a natural language explanation sentence.

Server tokenizes the prompt sentence into input tokens, performs neural network inference through the generative AI model, and decodes the output token sequence into text.

Input: Prompt sentence from Step 15.

Output: A natural language explanation sentence or paragraph that includes stepwise evacuation instructions and safety-related explanations.

Server may apply a decoding strategy such as beam search to balance fluency and determinism in the generated text.

### Step 17:

Server transmits the optimal evacuation route and the natural language explanation sentence to Terminal.

Server packages the route geometry, facility details, indices, and generated text into a response message and sends it via the communication network to the Terminal associated with the user.

Input: Optimal evacuation route from Step 13 and natural language explanation sentence from Step 16.

Output: A response message delivered to Terminal containing all guidance data required for display and voice output.

Server may compress or encode the route data to reduce network usage before transmission.

### Step 18:

Terminal presents the optimal evacuation route and the explanation to User via display and voice output.

Terminal parses the received route and explanation, renders the route on a map display with markers for the selected facility, and displays hazard level indicators and textual summaries. Terminal also uses a text-to-speech engine to output the explanation as spoken guidance.

Input: Response message from Server received in Step 17.

Output: Visual map display and audible navigation instructions presented to User.

User can then follow the displayed path and listen to the instructions to safely evacuate to the recommended facility.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional disaster guidance systems typically implement fixed algorithmic pipelines in which sensor data is processed by predetermined rules to compute a risk score, a closest shelter is selected based primarily on distance, and a static navigation path is returned to a user device. These systems suffer from several technical limitations in terms of computer technology itself.

First, hazard evaluation is often performed independently of downstream route computation and user interaction. Separate software components process seismic data, route data, and user-interface content without a unified representation of “situation context.” This fragmented architecture forces repeated data conversions between internal formats, increases memory copies and inter-process communication, and leads to latency and inconsistency between the hazard model and the routing logic.

Second, route-selection modules generally optimize for geometric distance or estimated travel time alone, without tightly integrating dynamically changing hazard data into the path search. Because the route planner is not driven by a rich, machine-interpretable context that combines up-to-date hazard levels, shelter capacity, and road conditions, the computing system cannot reliably prioritize safety under rapidly changing disaster conditions. As a result, the same computational engine may return suboptimal or even unsafe routes when incoming disaster data shifts.

Third, conventional systems treat the user as a passive endpoint and do not incorporate user state, such as emotional condition, into the core decision logic. Emotion-related information, if used at all, is handled only at the user-interface layer. This separation prevents the computing system from using emotion as a first-class input when orchestrating route updates, message structure, and interaction cadence, and leads to a mismatch between system behavior and the user's ability to process guidance under stress.

Fourth, existing deployments of generative AI models in disaster contexts are typically limited to free-form text generation based on manually crafted prompts. The system does not systematically construct prompt sentences from structured internal state (hazard values, route graphs, shelter metadata, user state) nor does it use these models as programmable components within a real-time control loop. Without a standardized prompt-generation layer tied to internal data structures, the computing system cannot reliably or efficiently produce consistent, context-aware guidance across different users and different hazard scenarios.

Accordingly, there is a need for a computer-implemented system that (i) unifies hazard evaluation, route selection, shelter selection, and user state into a consistent context representation; (ii) programmatically generates structured prompt sentences from this context; (iii) uses a generative AI model as a controllable computation unit for producing natural-language guidance; and (iv) reduces end-to-end decision latency and improves safety-aware route selection and user comprehension by tightly integrating these components within a single processor-controlled pipeline. The technical problem is to improve the way computing resources acquire heterogeneous data (sensor data, geospatial data, user-state data), transform that data into a unified, machine-usable “situation context,” and use that context to control a generative AI model and a user terminal so as to deliver low-latency, hazard-aware, and user-state-adaptive evacuation guidance.

The specific processing by the specific processing unit 290 of the data processing device 12 in Application Example 2 is realized by the following means.

The present invention provides a server comprising a processor configured to acquire disaster-related information including geospatial information, quantify a hazard level for each predetermined area on the basis of the acquired disaster-related information, acquire current position information from a user terminal, search and select one or more candidate evacuation facilities from an evacuation-facility data set on the basis of the current position information and the quantified hazard level, obtain a plurality of movement routes between the current position information and each of the candidate evacuation facilities by using a route-information providing service, determine an optimal evacuation route on the basis of the hazard level and traffic conditions, acquire user information including audio information and image information from the user terminal, specify an emotional state of a user by applying an emotion-recognition model to the user information, generate a prompt sentence to be input to a generative AI model, the prompt sentence including situation information comprising the hazard level, the candidate evacuation facilities, the optimal evacuation route, and the emotional state, input the prompt sentence to the generative AI model to cause the generative AI model to generate, as output, an evacuation-guidance message in natural language corresponding to the emotional state, and transmit the evacuation-guidance message and the optimal evacuation route to the user terminal so that the user terminal controls a display device and an audio output device to present the evacuation-guidance message and the optimal evacuation route. This enables the computing system to treat multi-source disaster data, geospatial data, and user-state data as a unified context, to drive a generative AI model through structured prompt sentences generated directly from that context, and to automatically produce and deliver low-latency, hazard-aware, and emotion-adaptive evacuation guidance, thereby improving the technical performance of hazard evaluation, route computation, and user interaction in a computer-implemented disaster-response environment.

The term “disaster-related information” refers to information indicative of an occurrence or potential occurrence of a natural or man-made hazardous event, including but not limited to seismic parameters, meteorological parameters, hydrological parameters, and associated geospatial attributes.

The term “geospatial information” refers to information that specifies a position, area, or geometry on or near the surface of the Earth, represented by coordinate values, regions, or map-related identifiers usable by a computing system.

The term “hazard level” refers to a numerical or categorical representation of an estimated degree of risk or potential damage associated with a disaster-related event in a particular area or along a particular route.

The term “predetermined area” refers to a spatial unit, such as an administrative region, grid cell, or map segment, that is defined in advance in a data structure and used as a basis for associating hazard levels and other attributes.

The term “user terminal” refers to an information processing device operated or carried by a user, such as a mobile communication device, computing device, or vehicle-mounted device, that is configured to communicate with a server and present information to the user.

The term “current position information” refers to information indicating a present geographic position of a user terminal, typically including coordinate data such as latitude and longitude and optionally including accuracy and time-stamp information.

The term “evacuation facility” refers to a physical location designated for temporary protection or shelter of persons during or after a hazardous event, such as a public shelter, assembly point, or refuge area.

The term “evacuation-facility data set” refers to structured data stored in a storage medium that associates evacuation facilities with attributes such as position, capacity, accessibility, and facility characteristics.

The term “candidate evacuation facility” refers to an evacuation facility that is selected by a computing system as a potential destination for a user based on at least current position information and hazard level information.

The term “route-information providing service” refers to a computing service, executed locally or remotely, that receives geographic input data and outputs movement routes, road conditions, traffic information, and related path data.

The term “movement route” refers to a sequence of positions, links, or segments in a transportation network that defines a path between a starting position and a destination position for traversal by a user.

The term “optimal evacuation route” refers to a movement route that is selected from a plurality of movement routes on the basis of one or more criteria, including at least hazard level and traffic conditions, and that is deemed preferable for evacuation in view of safety and travel time.

The term “traffic conditions” refers to information describing a state of a transportation network, including but not limited to congestion status, road closures, speed restrictions, and incidents, as detected or estimated by a computing system.

The term “user information” refers to data acquired from a user terminal that is related to a user, including but not limited to audio information, image information, and optionally additional sensor information.

The term “audio information” refers to time-varying data representing sound captured by an audio sensor, such as speech, vocal expressions, or environmental noise associated with a user.

The term “image information” refers to visual data captured by an imaging sensor, such as image frames or video frames that include a representation of at least a portion of a user.

The term “emotion-recognition model” refers to a trained computational model that receives user information as input and outputs an estimated emotional state or distribution over emotional states associated with the user.

The term “emotional state” refers to a classification or representation of a user's affective condition, such as calmness, confusion, fear, stress, or panic, as determined by an emotion-recognition model.

The term “situation information” refers to aggregated information that characterizes a current state of a disaster-response context, including at least hazard level information, candidate evacuation facility information, optimal evacuation route information, and emotional state information.

The term “prompt sentence” refers to text data or a structured textual representation that encodes instructions and context information to be provided as input to a generative AI model in order to control a type, style, or content of output generated by the generative AI model.

The term “generative AI model” refers to a trained computational model that generates output data, such as natural-language text, in response to input data including a prompt sentence, by performing learned transformations over internal parameters.

The term “evacuation-guidance message” refers to natural-language content generated or selected by a computing system that provides a user with instructions, explanations, or recommendations related to evacuation actions, destinations, or routes.

The term “natural language” refers to a human language, as opposed to a formal programming language, in which messages are expressed in grammatically coherent sentences understandable by a human user.

The term “display device” refers to a hardware component configured to visually present information, such as a screen or projection device integrated into or connected to a user terminal.

The term “audio output device” refers to a hardware component configured to output sound, such as a speaker or an earphone transducer, integrated into or connected to a user terminal.

The term “processor” refers to one or more processing circuits, such as central processing units, graphics processing units, or dedicated logic circuits, capable of executing instructions to perform the operations described in the specification.

In one embodiment, a server, a plurality of terminals, and one or more communication networks cooperate to implement the claimed system. The server includes at least one processor, a main memory, a non-volatile storage device, and a network interface. The processor may be a general-purpose central processing unit, a graphics processing unit, or a combination thereof. The server executes software components including an operating system, a database management system, a hazard-evaluation module, a routing module, an emotion-recognition interface module, and a generative-AI interface module.

The server stores disaster-related information, evacuation-facility information, user-session information, and model parameters in one or more data stores. In one example, the server uses a relational database management system such as a general-purpose SQL database to maintain tables for seismic events, regional hazard levels, evacuation facilities, and route caches. The server also stores learned parameters of neural-network models in a model-parameter repository accessible by the hazard-evaluation module and the emotion-recognition interface module.

The terminal includes a processor, a memory, a positioning component such as a global navigation satellite system receiver, an imaging component such as a camera, an audio input component such as a microphone, a display device, and an audio output device such as a speaker. The terminal executes an operating system, a location-service framework, camera and audio frameworks, and a client application that communicates with the server via a packet-based communication network.

The server acquires disaster-related information including geospatial information from multiple sources. In one configuration, the server accesses external data sources such as seismic-data application programming interfaces and meteorological-data application programming interfaces using a network interface. The server receives event records encoded in a structured format and converts them into internal data structures. The server parses each record into primitive fields such as magnitude, epicenter latitude, epicenter longitude, focal depth, occurrence time, and observation time. The server stores these fields in a seismic-event table having columns that include an event identifier, a region identifier, and the above parameters.

The server quantifies a hazard level for each predetermined area. The server maintains a region table that defines predetermined areas as cells in a grid or administrative regions and associates each region with geometric boundaries. The server computes, for each region, one or more feature vectors. Each feature vector may include a distance between the region centroid and one or more epicenter positions, time differences between the current time and the occurrence time of recent events, local soil parameters retrieved from a geophysical data source, population density, and built-environment indices. The server normalizes these feature values to a predefined numeric range. The server then feeds the resulting feature vectors into a hazard-evaluation model.

In one embodiment, the hazard-evaluation model is a feed-forward neural network implemented on a general-purpose machine-learning framework such as a tensor-based deep-learning library. The model architecture may include an input layer whose dimension equals the feature-vector dimension, one or more hidden layers with rectified linear unit activations, and an output layer that outputs a scalar hazard score. During training, the server or an offline training system uses a loss function such as mean squared error or cross-entropy with respect to historical damage labels, and updates model weights by gradient descent using an optimizer such as stochastic gradient descent or Adam. The server may perform data augmentation by simulating variations in event magnitude and distances to increase robustness. The trained model parameters are stored in the model-parameter repository.

At runtime, the server loads the trained hazard-evaluation model into memory and performs batch inference on feature vectors using matrix-multiplication operations on a processor or a graphics processing unit. The server obtains continuous-valued hazard scores for each region. The server then classifies each region into categories such as low, medium, or high hazard by comparing the hazard scores with threshold values. The server stores the scores and categories in a hazard-level table keyed by region identifier. By precomputing features and using batch inference, the server reduces redundant recalculation and improves processing throughput.

The terminal acquires current position information and user information. The terminal uses a location-service framework to obtain current geographic coordinates from the positioning component. The terminal may also use network-based positioning methods as a fallback. The terminal associates a timestamp with each location sample and sends the location samples to the server using a secure communication protocol. The terminal acquires audio information and image information from the microphone and camera. The terminal can preprocess audio by computing spectral coefficients such as mel-frequency cepstral coefficients and preprocess image frames by detecting facial landmarks. The terminal transmits either raw sensor data or compressed features to the server.

The server searches and selects one or more candidate evacuation facilities based on the current position information and the quantified hazard level. The server maintains an evacuation-facility table that stores facility identifiers, coordinates, capacity, occupancy estimates, accessibility attributes, and a facility type. The server computes a geographic distance between the user's current position and each facility using a distance formula. The server filters facilities whose regions have hazard levels above a threshold or whose capacity is below a threshold. The server calculates a facility score that combines distance, hazard level, and capacity using a weighted function. Facilities with high scores are designated as candidate evacuation facilities. By computing and storing a composite score, the server avoids repeated recalculation for each request.

The server obtains a plurality of movement routes between the current position information and each candidate evacuation facility by using a route-information providing service. The server calls a routing service application programming interface that accepts origin coordinates, destination coordinates, and routing parameters such as mode (walking, driving) and avoidance options (closed roads, hazard zones). The server receives route candidates as sequences of geographic points or graph edges, along with travel time estimates and descriptive instructions. The server also retrieves traffic conditions, including congestion indicators and road closures, by querying a traffic-information service or municipal open data.

The server determines an optimal evacuation route from the plurality of movement routes. In one embodiment, the server maps the route candidates to a graph representation where nodes correspond to road segments and edges represent transitions. The server associates each edge with a base cost equal to expected traversal time and an additional hazard cost equal to a function of the hazard level of the region containing the edge. The server runs a path-search algorithm such as A* search or Dijkstra's algorithm on this hazard-augmented graph. The heuristic used in the A* search may combine straight-line distance to the destination and a predicted hazard gradient. The server selects the route with the minimum total combined cost as the optimal evacuation route. This non-conventional integration of hazard cost into the routing algorithm improves safety at the computational level and is not a mere automation of manual map reading.

The server acquires user information including audio information and image information from the user terminal and specifies an emotional state of the user by applying an emotion-recognition model. In one embodiment, the server implements the emotion-recognition model as a convolutional-recurrent neural network for audio and a convolutional neural network for images, or a multimodal transformer that fuses both modalities. The model receives time-aligned acoustic features and visual features as input. The model produces logits for multiple emotion classes such as calm, confused, stressed, or panicked. During training, the server or a training component uses labeled emotion datasets, computes a cross-entropy loss, and updates weights by backpropagation. The server can apply class-weighting to handle imbalanced emotion labels and use regularization methods to prevent overfitting. At inference time, the server computes emotion probabilities and selects the emotional state corresponding to the highest probability. The server may smooth predictions over a sliding temporal window to mitigate noise.

The server generates a prompt sentence to be input to a generative AI model. The server first constructs a situation-information structure that aggregates the hazard level, data of the candidate evacuation facilities, data of the optimal evacuation route, and the emotional state. The server then instantiates a template stored in a prompt-template repository. The template defines a textual pattern with placeholders for current position, hazard category, facility names, route length, key instructions, and emotion labels. The server fills these placeholders with values from the situation-information structure. The resulting prompt sentence explicitly instructs the generative AI model how to respond. For example, when the user is in a panicked emotional state, the server may generate the following prompt sentence: “User is currently at latitude 35.6895 and longitude 139.6917 in an area with high seismic hazard. The nearest safe evacuation facility is a public shelter located approximately 1.2 kilometers away, with sufficient capacity and no reported structural damage. The optimal walking route has already been computed and avoids roads with high hazard levels and heavy traffic. The user's emotional state is ‘panic’. As a generative AI model, generate very short, calm, step-by-step evacuation instructions using simple words, avoiding technical terms, and include one or two reassuring sentences.”

When the user is in a calm state, the server may instead generate a different prompt sentence: “User is currently in a moderate hazard area at latitude 35.6895 and longitude 139.6917. Three evacuation facilities within 2 kilometers are available with sufficient capacity. Multiple possible routes are available, each with different travel times and hazard exposure. As a generative AI model, describe the three options clearly, compare their safety and travel time, and provide guidance to help the user choose one route.”

By constructing prompt sentences from structured internal data rather than free-form human input, the server improves control over the generative AI model, reduces ambiguity, and improves repeatability and latency compared to naive natural-language generation.

The server inputs the prompt sentence to the generative AI model and causes the generative AI model to generate an evacuation-guidance message in natural language corresponding to the emotional state. In one configuration, the generative AI model is a transformer-based language model hosted on a separate inference system. The server sends the prompt sentence over a secure transport connection, receives generated text tokens, and assembles them into a message. The generative AI model internally uses multi-head self-attention and feed-forward layers to compute the output. The model parameters are pre-trained on large corpora and optionally fine-tuned on disaster-related instructions. This generative process is not simply a template fill but a computed transformation over large parameter matrices, improving richness and adaptability of the message while preserving constraints encoded in the prompt sentence.

The server transmits the evacuation-guidance message and the optimal evacuation route to the user terminal. The server includes a route polyline, step-by-step navigation instructions, and metadata such as estimated arrival time. The terminal receives this data, stores it in application memory, and uses a mapping library to render the route on the display device. The terminal uses a text-to-speech engine to synthesize the evacuation-guidance message and plays it through the audio output device. The terminal adjusts volume or display emphasis depending on the emotional state specified by the server. For example, if the emotional state is panic, the terminal can highlight critical steps and reduce optional information.

The described configuration provides several technical effects. By encoding hazard levels directly into route edge costs and by batch-processing regional features with neural-network models, the server reduces the time required to generate updated safe routes when new disaster-related information arrives. By generating prompt sentences from structured situation data and by constraining the generative AI model via explicit instructions, the system reduces unnecessary token generation, lowers communication load between the server and the generative-AI inference subsystem, and improves determinism of responses. By performing multimodal emotion recognition with specialized neural architectures and smoothing, the server obtains a stable emotional state signal that is difficult to derive manually, enabling automatic adjustment of message complexity and style in real time. These features improve the overall computational pipeline, including memory usage, processing throughput, and response latency, and are not a mere substitution for human operators writing messages manually.

In another embodiment, the terminal performs a portion of the emotion-recognition inference locally. The terminal may execute a lightweight convolutional neural network optimized for mobile hardware. In this case, the terminal compresses sensor data less and sends only emotional state labels and confidence scores to the server. This reduces network bandwidth consumption and enhances privacy. The server then uses the received emotional state as an input to the situation-information structure and prompt sentence generation.

In a further embodiment, the server employs a variant hazard-evaluation model such as a graph neural network. The server represents regions as nodes in a graph and edges as adjacency relations, and defines node features based on seismic and environmental data. The graph neural network propagates information between nodes during training and inference so that hazard levels incorporate spatial correlations. The training process uses the same or similar loss functions but now includes graph convolution layers. This configuration can further improve hazard-level accuracy and, consequently, route safety.

In still another embodiment, the server maintains a cache of recent routes and associated hazard levels. When a new request arrives from a user terminal whose location and destination are close to a previously computed pair, the server reuses parts of the cached computation instead of recomputing all route candidates. The server updates only segments whose hazard costs changed significantly. This partial recomputation improves computation efficiency and reduces latency.

In an alternative configuration, the server selects prompt templates adaptively based on a combination of hazard level, route complexity, and emotional state. For simple, low-hazard routes, the server uses a minimal template that instructs the generative AI model to produce a short message. For complex, high-hazard routes, the server uses a detailed template that asks the model to structure the output into numbered steps or bullet-like segments. This template-switching mechanism is implemented as a ruleset evaluated by the processor and is different from conventional static user-interface logic because it directly controls the generative AI model's internal computation via the prompt sentence, influencing token distribution and thereby computational cost.

In yet another embodiment, the server logs situation information, generated prompt sentences, and generative-AI outputs to a training-data store. During offline periods, the server or another training system analyzes these logs and updates both the hazard-evaluation model and the generative-AI fine-tuning parameters. The training pipeline may use error functions that combine route safety outcomes and user feedback ratings. For example, if users frequently deviate from recommended routes or report confusion, the system adjusts template phrasing and model fine-tuning. This feedback loop improves system performance over time in a way not readily achievable by manual rule tuning.

The described embodiments can be applied not only to seismic events but also to other types of disasters. The server can extend the feature set to include wind speed, precipitation, river levels, or fire spread indices. The hazard-evaluation model can be retrained with new labels corresponding to other disaster types. The route-cost function can incorporate additional terms such as flood depth or smoke density. The overall architecture—unified situation-information structures, programmatic prompt sentence generation, hazard-aware routing, and emotion-adaptive messaging—remains the same, and thus the technical effects of improved computational efficiency, accuracy, and responsiveness are preserved.

Through these embodiments, the system uses specific data structures for hazard levels, facility records, route graphs, emotion labels, and prompt templates, and specific algorithmic flows for feature computation, neural-network inference, route search, and prompt-sentence generation. The server and terminal cooperate with concrete hardware components, such as positioning sensors, cameras, microphones, displays, and audio devices, to produce real-world control effects, namely, guiding a user along a physically safe path in response to changing disaster conditions. The combination of hazard-augmented routing, multimodal emotion recognition, and structured prompt sentence control of a generative AI model yields improved technical performance compared to traditional rule-based systems or manual workflows, and thus provides a practical and technically grounded implementation of the claimed invention.

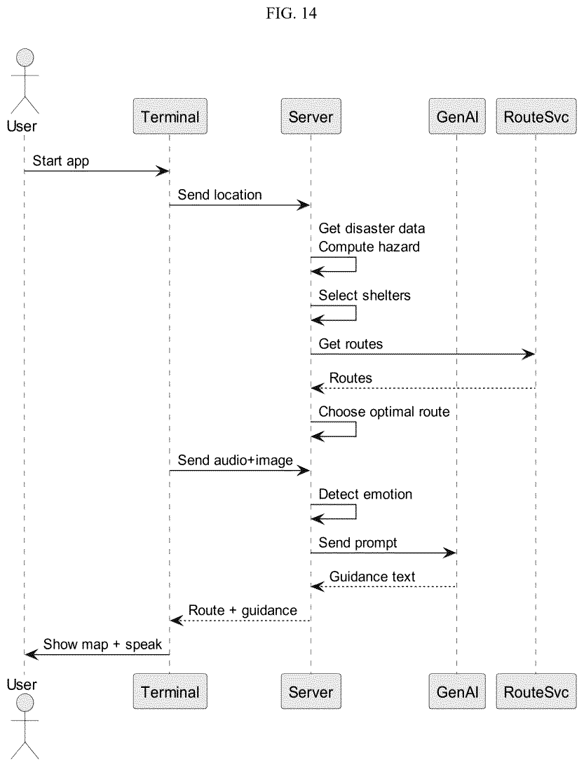

The following describes the processing flow using FIG. 14.

### Step 1:

Server acquires disaster-related information.

Server receives, as input, raw disaster-related records from external information sources via a communication network, the records including at least a magnitude value, an epicenter position, a depth value, and a time stamp.

Server parses the received records into primitive fields, converts coordinates and time stamps into internal formats, and performs data cleaning such as removing duplicates and discarding obsolete events.

Server stores, as output, normalized disaster-related records into a seismic-event table in a database, each record associated with a region identifier.

### Step 2:

Server computes regional hazard feature vectors.

Server reads, as input, the normalized disaster-related records and region definitions (region identifiers and geographic boundaries) from the database.

Server calculates, for each region, numerical features such as distance from each epicenter to the region centroid, time elapsed since each event, and optionally local environmental indices, and then normalizes these values into a fixed-length feature vector.

Server writes, as output, a set of region-specific feature vectors into a hazard-feature table, each feature vector linked to a region identifier.

### Step 3:

Server evaluates hazard levels using a trained model.

Server takes, as input, the region-specific feature vectors from the hazard-feature table.

Server loads a trained hazard-evaluation neural network model into memory and performs numerical operations (matrix multiplications, bias additions, and activation functions) on each feature vector to compute a continuous hazard score.

Server outputs hazard scores and hazard categories for each region and stores them in a hazard-level table, associating each region identifier with a numeric hazard score and a discrete hazard label.

### Step 4:

Terminal acquires current position information.

Terminal receives, as input, raw position data from a positioning component via a location-service framework, the raw data including at least latitude, longitude, accuracy, and a time stamp.

Terminal converts the raw position data into a standard coordinate format, attaches a session identifier for the user, and optionally filters out outdated or low-accuracy samples.

Terminal transmits, as output, a current-position message containing the cleaned coordinates and time stamp to the server over a secure communication channel.

### Step 5:

Server associates the user with a region and retrieves the relevant hazard level.

Server takes, as input, the current-position message from the terminal and the region definitions from the database.

Server determines which region polygon contains the user's coordinates by executing a point-in-polygon or spatial-index lookup, and retrieves the corresponding hazard score and hazard label from the hazard-level table.

Server outputs a user-context record that includes the user identifier, the region identifier, and the region's hazard score and label.

### Step 6:

Server selects candidate evacuation facilities.

Server receives, as input, the user-context record and an evacuation-facility table that includes coordinates, capacity, and associated region identifiers for each evacuation facility.

Server computes geographic distances between the user's current position and each facility using a distance function, filters out facilities in regions where the hazard score exceeds a threshold or where remaining capacity is insufficient, and then calculates a composite score that combines distance, hazard level, and capacity for each remaining facility.

Server outputs a ranked list of candidate evacuation facilities, each with its facility identifier, coordinates, and composite score.

### Step 7:

Server acquires route candidates from a route-information providing service.

Server takes, as input, the user's current position, the coordinates of each candidate evacuation facility, and routing parameters such as travel mode and avoidance options.

Server sends routing requests to an external route-information providing service and receives, for each origin-destination pair, one or more route candidates described as ordered sequences of positions or road-segment identifiers, each route candidate including a distance and an estimated travel time.

Server outputs a route-candidate set that associates each candidate evacuation facility with its corresponding route candidates and route metadata.

### Step 8:

Server determines an optimal evacuation route using hazard-augmented costs.

Server receives, as input, the route-candidate set, the hazard-level table, and optionally traffic-condition data indicating congestion and road closures.

Server maps each route candidate to a graph representation, assigns a base traversal cost to each edge based on travel time, adds a hazard cost based on the hazard score of the region that contains the edge, and optionally adds a traffic cost from the traffic-condition data.

Server executes a path-search algorithm such as Dijkstra's algorithm or A* search on the hazard-augmented graph to minimize total cost, and selects, as output, an optimal evacuation route that includes a sequence of coordinates or road segments, a total distance, and an updated estimated arrival time.

### Step 9:

Terminal acquires user audio and image information.

Terminal takes, as input, continuous signals from a microphone and a camera, the signals including the user's voice and face.

Terminal samples the audio signal into frames, converts each frame into acoustic features such as mel-frequency cepstral coefficients, captures image frames, and optionally detects and crops the region of interest surrounding the user's face using a local image-processing routine.

Terminal transmits, as output, a user-information packet containing the acoustic features and visual features, along with time stamps and a user identifier, to the server.

### Step 10:

Server estimates the user's emotional state.

Server receives, as input, the user-information packet containing acoustic and visual features.

Server loads an emotion-recognition model, such as a convolutional-recurrent neural network or a multimodal transformer, into memory and applies the model to the incoming features, performing internal computations including convolution, pooling, and attention over time to obtain class probabilities for predefined emotional states.

Server selects the emotional state associated with the highest probability, optionally smooths the result over a temporal window, and outputs an emotional-state record including the emotion label and its confidence.

### Step 11:

Server constructs situation information.

Server takes, as input, the user-context record, the ranked list of candidate evacuation facilities, the optimal evacuation route, and the emotional-state record.

Server aggregates these elements into a situation-information structure, which includes at least the current hazard label, numeric hazard score, selected facility identifier and attributes, route length and key turning points, and the emotional state label.

Server outputs the situation-information structure as a standardized internal object for downstream processing.

### Step 12:

Server generates a prompt sentence for a generative AI model.

Server receives, as input, the situation-information structure and a set of prompt templates stored in a template repository.

Server selects a template according to conditions such as the hazard label, route complexity, and emotional state, and then replaces placeholders in the template with concrete values from the situation-information structure, including current coordinates, facility description, route summary, and emotion label.

Server outputs a prompt sentence that encodes instructions and context, for example: “User is currently at latitude 35.6895 and longitude 139.6917 in an area with high seismic hazard. The nearest safe evacuation facility is a public shelter approximately 1.2 kilometers away. The optimal walking route avoids roads with high hazard levels and heavy traffic. The user's emotional state is ‘panic’. As a generative AI model, generate very short, calm, step-by-step evacuation instructions using simple words and include one or two reassuring sentences.”

### Step 13:

Server obtains an evacuation-guidance message from the generative AI model.

Server takes, as input, the prompt sentence and model parameters associated with a generative AI model, such as a transformer-based language model.

Server sends the prompt sentence to the generative AI model via an interface, waits for the model to execute internal attention and feed-forward operations to generate output tokens, and incrementally receives the tokens as intermediate results.

Server concatenates the tokens into a coherent evacuation-guidance message in natural language, optionally performs post-processing such as truncation or profanity filtering, and outputs the finalized evacuation-guidance message.

### Step 14:

Server prepares guidance data for the terminal.

Server receives, as input, the evacuation-guidance message and the optimal evacuation route.

Server packages these elements into a guidance payload that includes the full text of the message, a polyline or ordered list of route coordinates, step-by-step route instructions, and metadata such as estimated arrival time and emotion label.

Server outputs the guidance payload and transmits it to the terminal via a network interface.

### Step 15:

Terminal presents the evacuation-guidance message and route.

Terminal takes, as input, the guidance payload from the server.

Terminal decodes the route polyline into map coordinates, renders the route and evacuation facility on a digital map displayed on the display device, and passes the evacuation-guidance message to a text-to-speech engine to synthesize speech audio.

Terminal outputs, to the user, a combined presentation in which the route is shown visually and the message is spoken aloud via the audio output device.

### Step 16:

User follows the presented guidance.

User receives, as input, the visual map display and the spoken evacuation-guidance message from the terminal.

User interprets the instructions and physically moves along the indicated route, optionally providing manual input such as confirming receipt or requesting additional clarification via the terminal's user interface.

User's movement results in an updated real-world position, which becomes new current position information for subsequent iterations of the processing.

### Step 17:

Server monitors deviations and updates guidance if necessary.

Server receives, as input, updated current position information and optionally updated disaster-related information and traffic conditions.

Server compares the user's current position to the planned route, detects deviations or newly emerged hazards that significantly affect the route, and, if necessary, recomputes candidate facilities and an optimal evacuation route by repeating Steps 6 through 8 with the new inputs.

Server outputs an updated situation-information structure, generates a new prompt sentence and a revised evacuation-guidance message, and sends an updated guidance payload to the terminal, thereby maintaining route safety and relevance over time.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

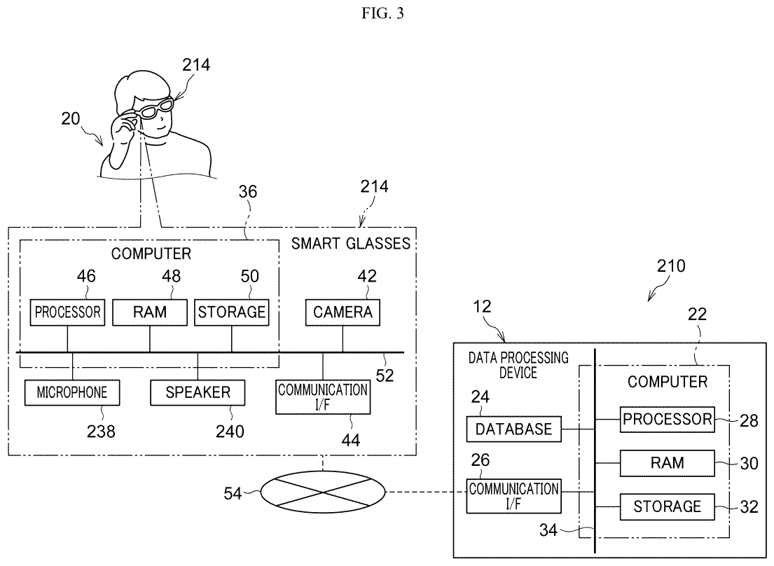

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

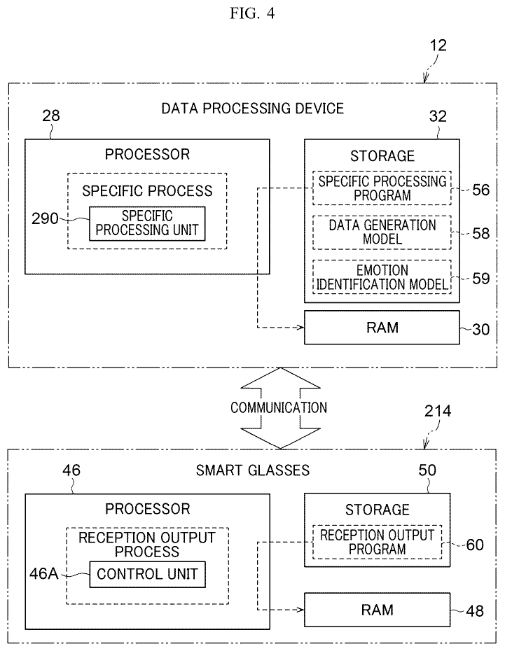

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

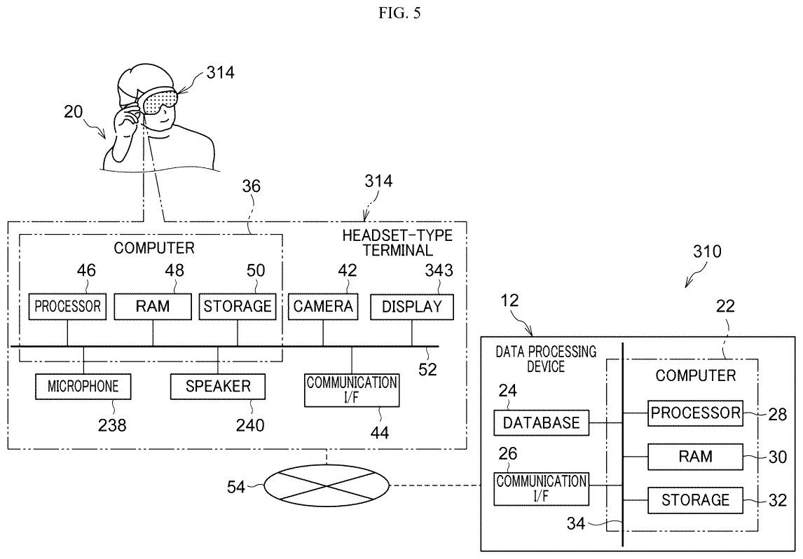

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

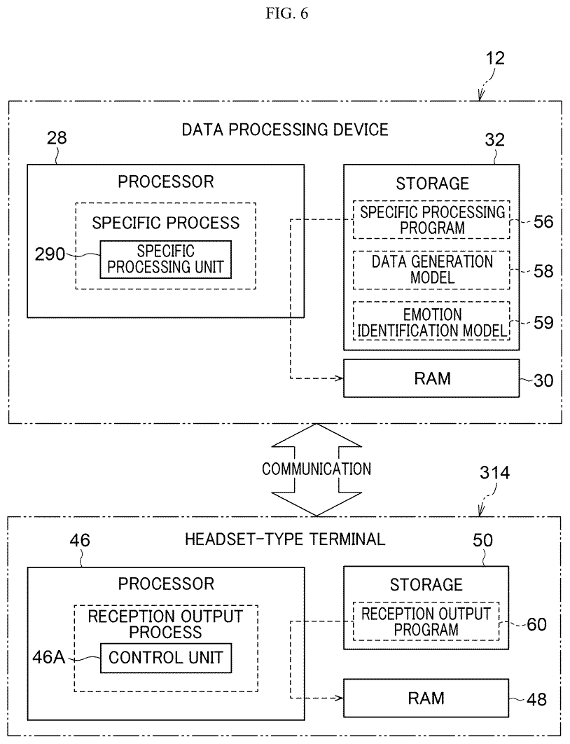

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

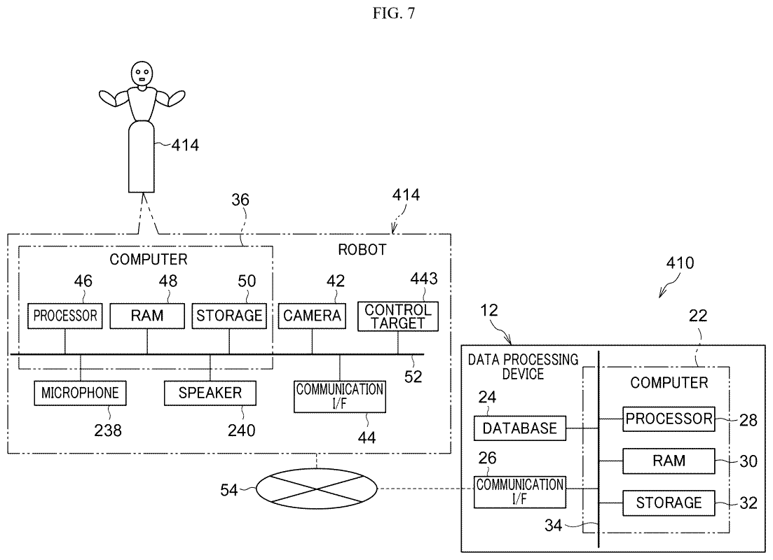

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

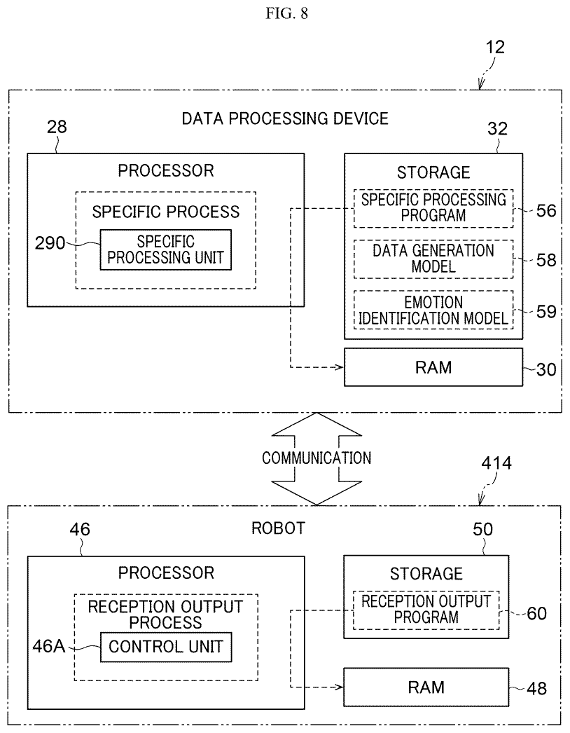

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

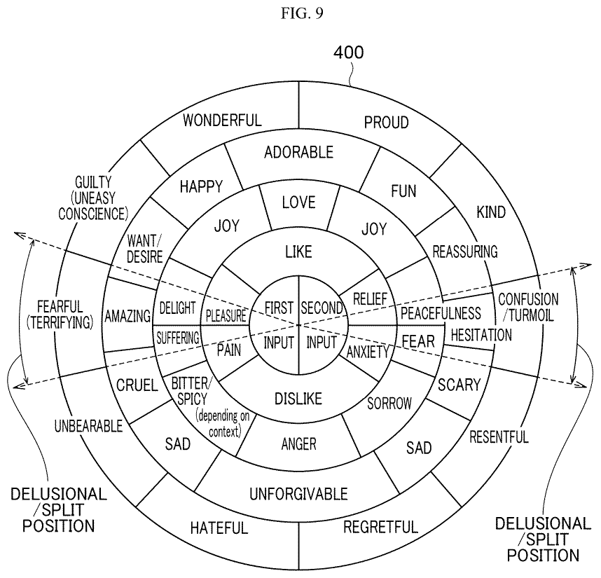

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

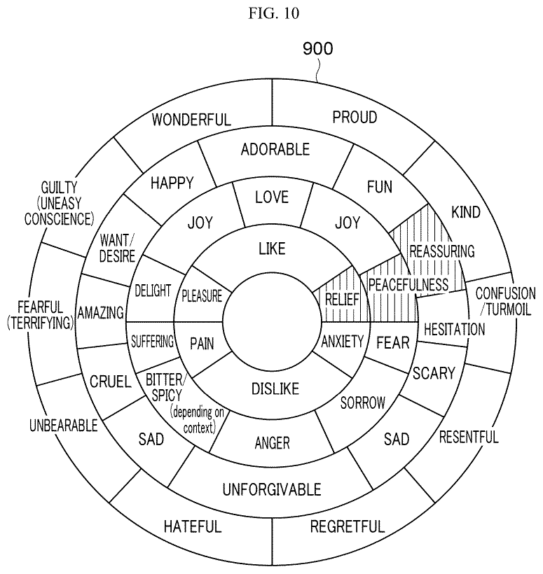

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
   acquire observation information by using an observation information acquisition unit,
   store the observation information in an information storage unit,
   calculate, by an arithmetic unit, a risk index for each predetermined area based on the observation information,
   generate, by a generation unit, request information to an external information provision unit for acquiring refuge facility information and route information based on the risk index and position information,
   generate, by a prompt generation unit, a prompt sentence to be input to a generative information processing model, the prompt sentence including as input elements the observation information, the risk index, the position information, the refuge facility information, and route constraint information, extract, by a route selection unit, refuge facility candidates and a plurality of evacuation route candidates from response information output from the generative information processing model, evaluate the evacuation route candidates, and specify an optimal evacuation route, and transmit, by a communication unit, route data including a sequence of positions constituting the optimal evacuation route, guidance instructions, and explanatory information to a terminal device.

### (Supplementary 2)

The system according to supplementary 1,
wherein the processor is configured to
   cause the prompt generation unit to use, as the observation information, a plurality of spatiotemporal parameters including event magnitude, event occurrence position, event depth, event occurrence time, and elapsed time after event occurrence as input elements,
   generate a prompt sentence for causing the generative information processing model to evaluate the risk index of the predetermined area based on the plurality of spatiotemporal parameters,
   obtain, by using the generative information processing model, natural language explanatory information relating to the risk index, and
   store, in the information storage unit, the risk index calculated by the arithmetic unit in association with the natural language explanatory information.

### (Supplementary 3)

The system according to supplementary 1,
wherein the processor is configured to
   cause the prompt generation unit to use, as the input elements, the position information, the refuge facility information, road condition information, and traffic condition information,
   generate a prompt sentence for instructing generation of explanatory information including a selection reason for an optimal refuge facility and an optimal evacuation route by the generative information processing model,
   obtain the explanatory information from the generative information processing model, and provide the explanatory information to the terminal device in association with the optimal evacuation route specified by the route selection unit.

### Application Example 1

### (Supplementary 1)

A system comprising a processor, a user terminal, and an autonomous mobile unit,
wherein the processor is configured to
   acquire disaster information from a geophysical observation apparatus and an information storage apparatus,
   associate position information, area information, and spatial information to calculate a risk level for each area,
   acquire candidate refuge facility information and movement path information from a geographic information providing apparatus and a mobile body information providing apparatus, and integrate the area-based risk level with the candidate refuge facility information and the movement path information to calculate an accessibility index for each candidate refuge facility,
   generate a prompt sentence including the disaster information, the area-based risk level, the candidate refuge facility information, and the movement path information as input data for a generative AI model,
   obtain, from the generative AI model, a natural-language risk evaluation result and a candidate refuge facility evaluation result, and determine, based on the natural-language risk evaluation result and the candidate refuge facility evaluation result, a candidate of an optimal refuge facility and a movement route to be presented to the user terminal,
   convert the candidate of the optimal refuge facility and the movement route into route information and transmit the route information to the user terminal and the autonomous mobile unit,
wherein the user terminal is configured to
   acquire a current position of a user by using a positioning apparatus, and
   display, on a display apparatus, a refuge facility and a guidance route based on the route information and the current position, and present sequential action instructions along the guidance route,
and wherein the autonomous mobile unit is configured to
   transport the user to the refuge facility while correcting a travel route in accordance with the route information and surrounding-environment information obtained from an onboard measurement apparatus.

### (Supplementary 2)

The system according to supplementary 1,
wherein the processor is configured to
   calculate the area-based risk level using data relating to a magnitude of an earthquake, a hypocenter position, a hypocenter depth, an occurrence time, and an elapsed time after the occurrence,
   generate a prompt sentence including the data as input data,
   and input the prompt sentence to the generative AI model to obtain the natural-language risk evaluation result.

### (Supplementary 3)

The system according to supplementary 1,
wherein the processor is configured to
   generate a prompt sentence including, as input data, current position information of the user, the candidate refuge facility information, road state information, and traffic condition information,
   input the prompt sentence to the generative AI model to obtain a natural-language proposal result relating to the optimal refuge facility and the movement route,
   and generate the route information to be provided to the user terminal and the autonomous mobile unit based on the natural-language proposal result.

### Example 2

### (Supplementary 1)

A system comprising a processor,
wherein the processor is configured to
   acquire seismic-related information from an external information providing apparatus, and
   read the seismic-related information from an information storage apparatus that stores the seismic-related information, and
   execute an evaluation algorithm that calculates a hazard index using the seismic-related information as input, and
   generate information acquisition conditions for acquiring evacuation facility information based on the hazard index and position information, and
   acquire the evacuation facility information from a public information providing apparatus or a local-government information providing apparatus, and
   acquire current position information from a position information acquisition apparatus, and transmit a route search request including the current position information and the evacuation facility information to a route search information providing apparatus, and acquire route candidate information including traffic condition information and road passability information, and
   calculate a safety index and a required-time index for the route candidate information and specify an optimal evacuation route based on the safety index and the required-time index, and generate structured data including the hazard index, the evacuation facility information, and the optimal evacuation route, and
   generate a prompt sentence including the structured data and input the prompt sentence to a generative information processing model to acquire a natural language explanation sentence, and transmit the optimal evacuation route and the explanation sentence to a terminal apparatus including a user display apparatus and a voice output apparatus.

### (Supplementary 2)

The system according to supplementary 1,
wherein the processor is configured to
   numerically calculate the hazard index by using as input at least magnitude information of a seismic event, hypocenter position information, hypocenter depth information, occurrence time information of the seismic event, and elapsed-time information, classify the hazard index into a plurality of hazard categories, and include the hazard categories in the structured data.

### (Supplementary 3)

The system according to supplementary 1,
wherein the processor is configured to
   generate the prompt sentence by providing, as textual input elements to the generative information processing model, at least current position information, evacuation facility position information, road condition information, traffic condition information, and route segment information included in the optimal evacuation route, and cause the generative information processing model to generate the natural language explanation sentence including stepwise evacuation action instructions for a user.

### Application Example 2

### (Supplementary 1)

A system comprising a processor,
wherein the processor is configured to
   acquire disaster-related information including geospatial information from an information acquisition unit,
   quantify a hazard level for each predetermined area by using the acquired disaster-related information and generating numerical hazard values,
   acquire current position information from a user terminal, search and select one or more candidate evacuation facilities from an evacuation-facility data set on the basis of the current position information and the quantified hazard level,
   obtain a plurality of movement routes between the current position information and each of the candidate evacuation facilities by using a route-information providing service, and determine an optimal evacuation route on the basis of the hazard level and traffic conditions,
   acquire user information including audio information and image information from the user terminal, specify an emotional state of a user by applying an emotion-recognition model to the user information,
   generate a prompt sentence to be input to a generative AI model, the prompt sentence including situation information comprising the hazard level, the candidate evacuation facilities, the optimal evacuation route, and the emotional state,
   input the prompt sentence to the generative AI model to cause the generative AI model to generate, as output, an evacuation-guidance message in natural language corresponding to the emotional state, and
   transmit the evacuation-guidance message and the optimal evacuation route to the user terminal so that the user terminal controls a display device and an audio output device to present the evacuation-guidance message and the optimal evacuation route.

### (Supplementary 2)

The system according to supplementary 1,
wherein the processor is configured to
   acquire, as the disaster-related information, time-series data including a magnitude of a seismic event, a source location of the seismic event, a depth of occurrence, an occurrence time, and an elapsed time after the occurrence, generate feature data for hazard evaluation by using the time-series data, quantify the hazard level on the basis of the feature data, and include the quantified hazard level in the prompt sentence to be input to the generative AI model.

### (Supplementary 3)

The system according to supplementary 1,
wherein the processor is configured to
   include, in the prompt sentence to be input to the generative AI model, the current position information, evacuation-facility information including locations and capacities of the candidate evacuation facilities, and route-related information indicating road conditions and traffic conditions, and cause the generative AI model to generate a natural-language expression that explains, among a plurality of evacuation-route candidates, the optimal evacuation route on the basis of safety and travel time, and to include the natural-language expression in the evacuation-guidance message.

What is claimed is:

1. A system comprising:
circuitry configured to:
receive, via a communication interface coupled to a packet-switched network, observation data from at least one external information providing apparatus;
calculate, based on the observation data, a risk index value for each of a plurality of predetermined areas;
generate request data for acquiring facility information from at least one second external information providing apparatus based on the risk index value and position data;
receive, via the communication interface, the facility information and path information associated with the plurality of predetermined areas;
generate a prompt sentence for instructing a generative neural network model to evaluate the risk index value, the facility information, and the path information and to generate guidance data; and
transmit, via the communication interface, the guidance data to a terminal device.

2. The system according to claim 1, wherein the circuitry is further configured to:
receive, via the communication interface, from the terminal device, current position data; and
generate route calculation request data based on the current position data and the facility information, transmit the route calculation request data to a route information providing apparatus, and receive route candidate data comprising a plurality of candidate paths.

3. The system according to claim 2, wherein the circuitry is further configured to:
calculate, for each candidate path, a safety index based on the risk index value and path constraint data; and
calculate, for each candidate path, a required-time index based on traffic state data associated with the candidate path.

4. The system according to claim 3, wherein the circuitry is further configured to:
specify an optimal path from the plurality of candidate paths by evaluating a composite metric combining the safety index and the required-time index; and
generate structured data comprising the risk index value, the facility information, and the optimal path.

5. The system according to claim 4, wherein the observation data comprises earthquake information including at least one of a magnitude value, an epicenter position, a depth value, an occurrence time, and an elapsed time after occurrence, and the risk index value represents a degree of seismic hazard for each predetermined area.

6. The system according to claim 5, wherein the facility information comprises evacuation facility information including at least one of a facility position, a capacity value, and an accessibility attribute, and the optimal path represents an optimal evacuation route from the current position data to a selected evacuation facility.

7. The system according to claim 6, wherein the circuitry is further configured to:
generate the prompt sentence including the structured data and input the prompt sentence to the generative neural network model to acquire a natural language explanation sentence; and
transmit the optimal path and the natural language explanation sentence to the terminal device to cause the terminal device to render a route display and output the natural language explanation sentence via at least one of a display device and an audio output device.

8. The system according to claim 1, wherein the circuitry is further configured to:
associate the position data with area boundary data to determine which predetermined area corresponds to the position data; and
compute, for each predetermined area, a feature vector comprising at least a distance parameter, a temporal decay parameter, and a normalized magnitude parameter derived from the observation data.

9. The system according to claim 8, wherein the circuitry is further configured to:
apply a trained evaluation model to the feature vector to generate a continuous risk score; and
classify the continuous risk score into a discrete risk category by comparing the continuous risk score with threshold values.

10. The system according to claim 9, wherein the trained evaluation model comprises a feed-forward neural network having an input layer, at least one hidden layer with an activation function, and an output layer that outputs the continuous risk score.

11. The system according to claim 1, wherein the circuitry is further configured to:
calculate an accessibility index for each facility represented in the facility information by evaluating a path cost from a reference position to each facility, the path cost comprising at least a distance component, a time component, and a risk penalty component derived from the risk index value; and
rank the facilities based on the accessibility index.

12. The system according to claim 11, wherein the circuitry is further configured to:
execute a path search algorithm on a graph representation of a transportation network, the graph comprising nodes representing positions and edges representing path segments, each edge having a composite cost comprising a base traversal cost and a hazard cost derived from the risk index value of the predetermined area containing the edge.

13. The system according to claim 12, wherein the path search algorithm comprises at least one of a Dijkstra algorithm or an A-star algorithm, and the hazard cost is computed as a function of a distance between the edge and a high-risk area.

14. The system according to claim 1, wherein the circuitry is further configured to:
transmit, via the communication interface, route information to an autonomous mobile unit; and
receive, from the autonomous mobile unit, updated path constraint data based on surrounding-environment information detected by an onboard measurement apparatus of the autonomous mobile unit.

15. The system according to claim 1, wherein the circuitry is further configured to:
apply a state estimation function to input signal data received from the terminal device to generate a state classification label; and
include the state classification label in the prompt sentence to cause the generative neural network model to adapt a style and content of the guidance data based on the state classification label.

16. The system according to claim 15, wherein the state estimation function comprises an emotion identification model, the input signal data comprises at least one of audio data and image data captured by the terminal device, and the state classification label represents an estimated emotional state of a user.

17. The system according to claim 16, wherein the circuitry is further configured to:
select a prompt template from a plurality of stored prompt templates based on the state classification label and the risk index value; and
generate the prompt sentence by populating the selected prompt template with the risk index value, the facility information, the path information, and the state classification label.

18. The system according to claim 1, wherein:
the circuitry is configured to:
receive, via the communication interface coupled to the packet-switched network, the observation data from the at least one external information providing apparatus;
calculate the risk index value for each of the plurality of predetermined areas based on the observation data;
receive, from the terminal device, current position data;
generate the request data and receive the facility information;
generate route calculation request data and receive route candidate data;
calculate a safety index and a required-time index for each route candidate;
specify an optimal path based on the safety index and the required-time index;
generate the prompt sentence including the risk index value, the facility information, and the optimal path and input the prompt sentence to the generative neural network model to acquire the guidance data; and
transmit the optimal path and the guidance data to the terminal device.

19. The system according to claim 18, wherein the circuitry is further configured to:
receive updated observation data and recalculate the risk index value; and
regenerate the prompt sentence and acquire updated guidance data when the recalculated risk index value differs from a previously calculated risk index value by more than a predetermined threshold.

20. A method performed by circuitry, the method comprising:
receiving, via a communication interface coupled to a packet-switched network, observation data from at least one external information providing apparatus;
calculating, based on the observation data, a risk index value for each of a plurality of predetermined areas;
generating request data for acquiring facility information from at least one second external information providing apparatus based on the risk index value and position data;
receiving, via the communication interface, the facility information and path information associated with the plurality of predetermined areas;
generating a prompt sentence for instructing a generative neural network model to evaluate the risk index value, the facility information, and the path information and to generate guidance data; and
transmitting, via the communication interface, the guidance data to a terminal device.
